(19) United States
(12) Patent Application Publication
(10) Pub. No.: US 2026/0307471 A1
(43) Pub. Date: Oct. 8, 2026

(54) POWER CONTROL AND ACCESSORIES SYSTEM

(71) Applicant: Cummins Inc., Indianapolis, IN (US)

(72) Inventors: Melissa M. Hernandez, Indianapolis, IN (US); Amir Riahi, Indianapolis, IN (US); Mana Sriphet, San Diego, CA (US); Mervyn Villanueva, Indianapolis, IN (US); Ameya S. Jathar, San Diego, CA (US); Lingjia Tao, Indianapolis, IN (US); Jorge Rosales, Indianapolis, IN (US); Victor Mishurov, San Marcos, CA (US); Adam Harrison Thorp, Temecula, CA (US); Kreteeka Chaudhury, Oceanside, CA (US); Arun Bhivaji Ghadge, Rochester Hills, MI (US)

(21) Appl. No.: 19/480,604

(22) PCT Filed: Jul. 10, 2024
(86) PCT No.: PCT/US2024/037473

§ 371 Date: Oct. 31, 2025

Related U.S. Application Data
(60) Provisional application No. 63/525,891, filed on Jul. 10, 2023.

(51) Int. Cl. B60K 11/02; B60H 1/00

(52) U.S. Cl. CPC B60K 11/02; B60H 1/00278; B60H 1/00428

(57) ABSTRACT

A power control and accessory system (PCAS) module configured for use in a vehicle and including a thermal management system (TMS), a distribution assembly, a first power distribution unit, and a second power distribution unit. The TMS including a housing and configured to receive and supply fluids to one or more vehicle accessories. The distribution assembly fixed to and lying along a first sidewall of the TMS housing and configured to distribute electrical power. The first power distribution unit provided with one or more first power distribution receptacles arranged to face in a first direction. The second power distribution module provided with one or more second power distribution receptacles arranged to face in a second direction, the second direction being different than the first direction, the first and second power distribution receptacles configured to route electrical power to and from the distribution assembly.

### CROSS-REFERENCE TO RELATED APPLICATIONS

This application is the U.S. National Phase of PCT/US2024/037473 filed Jul. 10, 2024, which claims the benefit of U.S. provisional application Ser. No. 63/525,891 filed Jul. 10, 2023, the disclosure of which is hereby incorporated in its entirety by reference herein.

### TECHNICAL FIELD

The present disclosure relates to control and distribution of power and thermal management assemblies for use in electric vehicle systems, in particular medium duty, heavy duty, off-highway, school buses, construction, and mining electric vehicles.

### BACKGROUND

Vehicles, in particular electric vehicles, include relatively complicated systems to enable propulsion, charging, heating and cooling the cabin and vehicle components disposed outside of the cabin.

### SUMMARY

According to one aspect of this disclosure, a power control and accessory system (PCAS) module configured for use in a vehicle is provided. The PCAS module may include a thermal management system (TMS), a distribution assembly, a first power distribution unit, and a second power distribution unit. The TMS may be configured to receive and expel one or more fluids to one or more vehicle accessories, and the TMS may include a TMS housing provided with one or more sidewalls. The distribution assembly may be fixed to and lie along a first sidewall of the one or more sidewalls of the TMS housing and the distribution assembly may be configured to distribute electrical power to the one or more vehicle accessories. The first power distribution unit may be provided with one or more first power distribution receptacles that may be arranged to face in a first direction. The second power distribution module may be provided with one or more second power distribution receptacles that may be arranged to face in a second direction, the second direction being different than the first direction.

According to another aspect of this disclosure, a power control and accessory system (PCAS) configured for use in a vehicle, the vehicle including a vehicle chassis provided with a front end and a rear end and a longitudinal vehicle axis extending therebetween, an energy storage system and a cabin module the cabin module configured to provide conditioned air to a cabin of the vehicle. The PCAS may include a distribution assembly and a thermal management system (TMS). The distribution assembly may be provided with a distribution housing configured to house one or more electrical circuits. The TMS may be directly connected to the distribution housing and configured to route refrigerant to the cabin module and route coolant to a coolant structure disposed in or defined by the distribution housing. The TMS may be disposed closer to the front end of the vehicle chassis than the rear end of the vehicle chassis.

According to yet another aspect of this disclosure, a power control and accessory system (PCAS) module configured for use in a vehicle is provided. The PCAS module may include a thermal management system (TMS), a distribution assembly, and a core assembly. The TMS may be configured to receive and supply one or more fluids to one or more vehicle accessories. The TMS may include a TMS housing formed by one or more sidewalls and a top wall extending between the one or more sidewalls. The distribution assembly may be fixed to and lie along a first sidewall of the one or more sidewalls of the TMS housing, and the distribution assembly may be disposed between the core assembly and the TMS housing. A converter may be disposed within at least one of the core assembly and the distribution assembly. The converter may be configured to receive voltage from a first power source and distribute the electric power at a second voltage from distribution assembly to the one or more vehicle accessories. Some of the one or more vehicle accessories may be disposed above the top wall of the TMS housing.

### BRIEF DESCRIPTION OF THE DRAWINGS

FIGS. 1 and 2 illustrate a number of schematic diagrams of exemplary battery electric vehicles (BEVs) and exemplary fuel cell electric vehicles (FCEVs) and positioning of a power control and accessories system (PCAS) within the BEVs and FCEVs.

FIG. 3A illustrates a top view of a front portion of an exemplary vehicle and the PCAS positioned therein.

FIG. 3B illustrates a plan view of the front portion of the exemplary vehicle and PCAS shown in FIG. 3A.

FIG. 4. illustrates a plan view of an exemplary PCAS disposed in a frame rail terminal tractor.

FIG. 5 illustrates a perspective view of an exemplary PCAS according to one or more embodiments.

FIGS. 6A and 6B illustrate perspective views of the exemplary PCAS shown in FIG. 5.

FIGS. 7 and 8 illustrate plan views of another exemplary PCAS.

FIG. 9 illustrates an exploded-perspective view of the PCAS shown in FIGS. 7 and 8.

FIG. 10 illustrates a partial-exploded-perspective view of the PCAS shown in FIGS. 7 and 8.

FIGS. 11 and 12 illustrate perspective views of a vehicle accessory configured to be mounted to the TMS.

FIG. 13 illustrates a perspective view of an onboard charger assembly configured to be mounted to the PCAS.

FIG. 14 illustrates a perspective view of a junction box of a high-voltage power distribution unit (HVPDU) according to one or more embodiments.

FIG. 15 illustrates a perspective view of electric connections of the junction box shown in FIG. 14.

FIG. 16 illustrates another perspective view of the electric connections of the junction box shown in FIG. 15.

FIG. 17 illustrates a front-perspective view of an interface of the HVPDU.

FIG. 18 illustrates a partial plan view of a distribution assembly for use in the PCAS according to one or more embodiments.

FIG. 19 illustrates a plan view of the distribution assembly shown in FIG. 18.

FIG. 20 illustrates a perspective view of the distribution assembly shown in FIG. 18.

FIGS. 21 and 22 illustrate exploded-perspective views of the distribution assembly shown in FIG. 18.

FIG. 23 illustrates an exploded-perspective view of a low-voltage power distribution unit (LVPDU) according to one or more embodiments.

FIG. 24 illustrates a perspective view of the LVPDU shown in FIG. 23.

FIG. 25 illustrates an exemplary schematic diagram of a vehicle thermal management architecture.

FIG. 26 and FIG. 27 each illustrate perspective views of an exemplary thermal management system (TMS) of the PCAS.

FIG. 28 shows a packaging window surrounding internal components of an exemplary TMS.

FIGS. 29A and 29B illustrate perspective views of the TMS shown in FIG. 28.

FIG. 30 illustrates a perspective-exploded view of an exemplary valve for use in the TMS.

FIG. 31 through FIG. 34 show schematic fluid diagrams of an exemplary vehicle which includes the TMS.

FIGS. 35A and 35B show another schematic fluid and electrical diagram of an exemplary vehicle which includes the TMS.

FIGS. 36A and 36B show another schematic fluid diagram of an exemplary vehicle which includes the TMS.

FIG. 37 illustrates a single-line layout diagram of the PCAS electrical system according to one or more embodiments.

FIG. 38 illustrates a boundary diagram of the TMS of the PCAS.

FIG. 39 illustrates a high-voltage interlock circuit.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This invention is not limited to the specific embodiments and methods described below, as specific components and/or conditions may, of course, vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within +0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Electrification of vehicles, in particular, medium and heavy-duty vehicles, such as buses, off-highway vehicles, tractor trailers, firetrucks, mining vehicles and any other vehicle having a gross vehicle weight rating ranging between 6,000 pounds to over 33,000 pounds, poses several challenges to the transportation industry. One of these challenges includes achieving smooth, reliable control of electric medium and heavy-duty vehicles and assuring that the integrated electric drive system, which powers the vehicle, works seamlessly with the vehicle's power system, controls, and displays. In addition to regulating drive motor speed as well as other operating characteristics to assure smooth acceleration, hill-climbing, regenerative braking, and other control aspects, a system is needed to provide reliable control and operation of the vehicle accessories, such as power steering, climate control, braking, charging, and others. And the integrated electric drive system may include a Power Control and Accessory Subsystem (PCAS) configured to provide such reliable control and operation.

This problem is compounded by the fact that the electric control system must be applied to multiple types of vehicles each of which may employ accessories with varying operating parameters. As one non-limiting example and as described herein, the PCAS is configured for use in medium-duty (MD) trucks, heavy-duty (HD) trucks, buses, and terminal tractors. It should be understood that the term “heavy-duty vehicles” includes but is not limited to sleeper cabs or long haul trucks, a day cabs, or cab over engine trucks, dump trucks, and refuse trucks. The term “medium duty” may include front engine buses, class 6-7 trucks, and cab over trucks. The PCAS may also be employed in rear engine buses (including low floor and standard floor chassis). Each of these vehicles may employ one or more accessories such as pneumatic or electric brakes, a hydraulic pump, climate control, a pre-charge module, electrified power take-off module (ePTO), direct current (DC) fast charging, a DC-DC converter, and an on-board charger.

The PCAS may be compatible with vehicles that operate at varying voltages, such as twelve volts or twenty-four volts, or other voltages as required. For vehicles employing pneumatic brakes, the PCAS may include a brake air compressor configured to provide a flow-rate of 13.4 cfm at eight bar or 13.4 cfm at ten bar, or a flow rate of 14.5 cfm at 13 bar. A hydraulic pump may be part of the PCAS assembly and the hydraulic pump may provide a flowrate of 16 lpm, 24 lpm, or 18.5 lpm at 186 bar, and up to 25 lpm at 206.8 bar, or another flowrate, as required. If the vehicle includes electric brakes or electric steering, the PCAS may include one or more motors to power the electric brake and steering systems. The PCAS may have a thermal load capacity that may range between 15 kW and 120 kW so that one or more of the vehicle cabin, batteries, converters, inverters, and more may be cooled or heated as required. As stated earlier, the PCAS may include a pre-charge module which may limit inrush current prior to or as the vehicle is turned on. A connector such as an ePTO connector may be provided to supply up to 200 kW for electric power take-off operations and another connector may be provided to enable DC fast charging of up to 300 kW. The DC-DC converter may be configured to convert up to 20 kW. The on-board charger may be configured to provide 11 kW, 22 kW, or another quantity of electric power, as required.

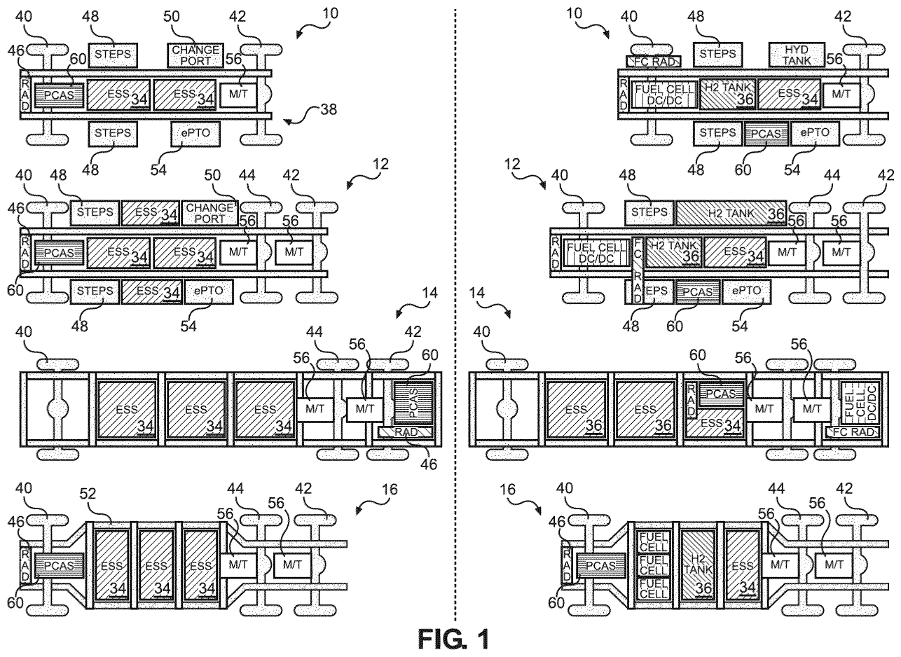

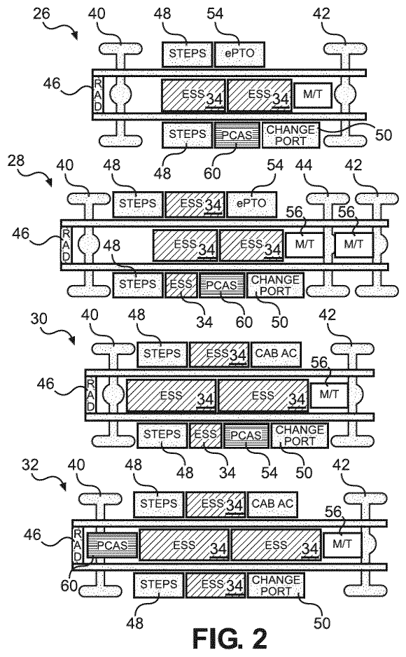

FIGS. 1 and 2 show various vehicle schematic diagrams and the relative location of the PCAS 60 in the different vehicles. The vehicles may be battery electric vehicles (BEV) or fuel cell electric vehicles (FCEV). The different BEVs may include a frame rail, which includes a wide terminal tractor and a standard medium-duty and heavy-duty classes, a low floor frame, and a purpose built chassis. In some BEVs, such as the frame rail for the wide terminal tractor and the medium-duty and heavy-duty vehicles as well as the purpose built chassis, the PCAS may be positioned behind the radiator and in front of the ESS. The PCAS may be positioned behind the motor-transmission unit and adjacent to the radiator.

FIG. 1 shows a schematic diagram of a frame rail wide terminal tractor BEV—PCAS front mount 10, a frame rail standard MD/HD BEV—PCAS front mount 12, a low floor frame (LFF) frame BEV—PCAS rear mount 14, a purpose built chassis (PBC) BEV—PCAS front mount 16, a frame rail wide terminal tractor FCEV—PCAS side mount 18, a frame rail standard MD/HD FCEV—PCAS side mount 20, a LFF FCEV—PCAS mid mount 22, and a PBC FCEV—PCAS front mount 24. FIG. 2 shows a frame rail wide terminal tractor BEV—PCAS side mount 26, a frame rail standard MD/HD BEV—PCAS side mount 28, a standard MD frame (e.g., school bus) BEV—PCAS side mount 30, and a standard MD frame (e.g., school bus) BEV—PCAS under hood mount 32. The vehicles 10-32 listed above are a non-exhaustive list and this disclosure contemplates other types of vehicles not specifically provided for.

In the frame rail wide terminal tractor BEV—PCAS front mount 10, the PCAS 60 may be disposed above a front axle 40 that extends between a pair of frame rails 38. The PCAS 60 may be fluidly connected to a radiator 46 that may be disposed forward of the PCAS 60 and electrically connected to one or more ESS modules 34 that are disposed rearward of the PCAS 60 and between the frame rails 38. The PCAS 60 may also be electrically connected to a charge port 50 that may be disposed on one of the frame rails 38 and rearward of steps 48. An electric power-take off (ePTO) module 54 may be disposed on another of the frame rails 38 and electrically connected to the PCAS 60. The ePTO may be operatively connected to an electric drive unit 36 that may be disposed adjacent to and operatively connected to a rear axle 42.

The frame rail standard MD/HD BEV—PCAS front mount 12 may include a mid-axle 44 disposed between the front axle 40 and the rear axle 42, and the mid-axle 44 and the rear axle 42 may each be coupled to an electric drive unit 36. A pair of ESS modules 34 may be disposed between the PCAS 60 and the drive unit 56 fixed to the mid-axle 44, a third ESS module 34 may be disposed between the steps 48 and the ePTO 54, and a fourth ESS module 34 may be disposed between the steps 48 and the charge port 50.

The PBC BEV—PCAS front mount 16 may include a pair of custom-built frame rails 52 fixed to the front axle 40, the mid-axle 44, and the rear axle 42. The PCAS 60 may be disposed over the front axle 40 and behind the radiator 46. Three ESS modules 34 may be disposed between the drive unit 56 fixed to the mid-axle 44.

The PCAS 60 of the LFF frame BEV—PCAS rear mount 14 may be disposed rearward of the rear axle 42 and the radiator 46 may be disposed adjacent to the PCAS 60 and arranged parallel to a longitudinal axis of the vehicle 14. The ESS modules 34 may be disposed forward of the drive unit 56 fixed to the mid-axle 44 and rearward of the front axle 40.

The frame rail wide terminal tractor FCEV—PCAS side mount 18 may include a fuel cell DC/DC converter disposed above the front axle 40 and rearward of the radiator 46. The radiator 46 may be configured to regulate the temperature of the ESS module 34 that may be disposed between the fuel cell 58, the vehicle DC/DC converter 64, and a hydrogen tank 36. The PCAS 60 may be disposed between the steps 48 and the ePTO 54 and another hydrogen tank 36 may be disposed rearward of steps on the frame rail 38 opposite the frame rail 38 that the PCAS 60 is fixed to.

The PCAS 60 of the frame rail standard MD/HD FCEV—PCAS side mount 20 may be fixed to one of the frame rails 38 and between the ePTO 54 and the steps 48. The fuel cell radiator 62 may be disposed between the fuel cell 58 and vehicle DC/DC converter 64 and one of the hydrogen tanks 36. Another hydrogen tank 36 may be disposed between the steps 48 and the mid-axle 44. The LFF FCEV—PCAS mid mount 22 may include a pair of hydrogen tanks 36 that may be disposed rearward of the front axle 40 and forward of the radiator 46 and the radiator 46 may be disposed adjacent to the ESS module 34 and the PCAS 60 which may be collectively disposed forward of the drive unit 56 fixed to the mid-axle 44. The fuel cell radiator 62 and the fuel cell DC/DC converter may each be disposed rearward of the rear axle 42.

The PCAS 60 of the PBC FCEV—PCAS front mount 24 may be disposed above the front axle 40 and between the radiator 46 and the fuel cell radiator 62. The PBC FCEV—PCAS front mount 24 includes a pair of purpose built chassis frame rails 52 and the ESS module 34, hydrogen tank 36, and fuel cell radiator 62 may be disposed between central portions of each of the frame rails 52. The PCAS 60 may be disposed forward of the fuel cell radiator, above the front axle 40, and rearward of the radiator 46.

One or more vehicles contemplated herein, such as the standard MD frame (e.g., school bus) BEV—PCAS side mount 30 and the standard MD frame (e.g., school bus) BEV—PCAS under hood mount 32 may include a cabin module 66 configured to regulate the temperature of the vehicle cabin. In one or more embodiments, the cabin module 66 may be fixed to one of the frame rails 38 and disposed between an ESS module 34 and the rear axle 42.

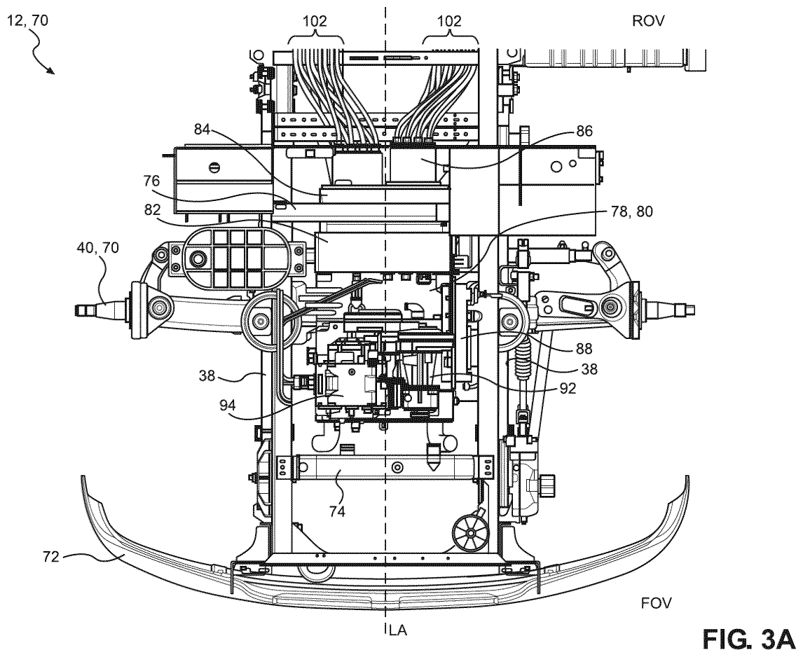

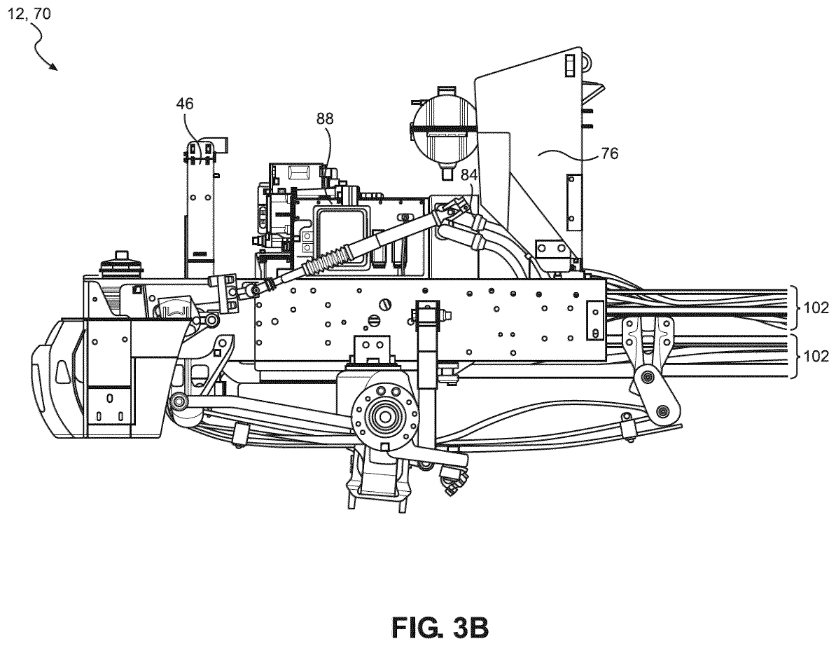

FIG. 3A shows a top view of a front end of an exemplary vehicle such as a school bus 68. FIG. 3B plan a plan view of the front portion of the exemplary vehicle and PCAS shown in FIG. 3A. The vehicle 68 includes a front axle such as a steer axle 70, a pair of frame rails 38, and a cross-member 74. The cross member 74 may be configured to support a heat exchanger (e.g., radiator). For clarity, the cabin, hood, and fenders among other portions of the vehicle 68 are not shown. A longitudinal axis LA of the vehicle 68 may extend from the rear of the vehicle ROV to the front of the vehicle FOV. A barrier such as a firewall 76 may be disposed rearward of the steer axle 70 and one or more portions of the PCAS 60.

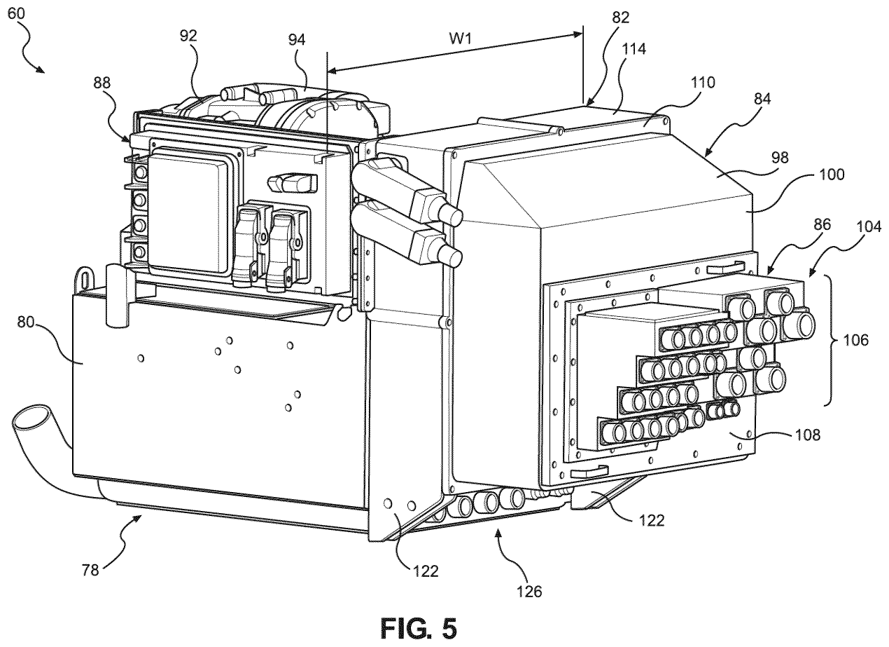

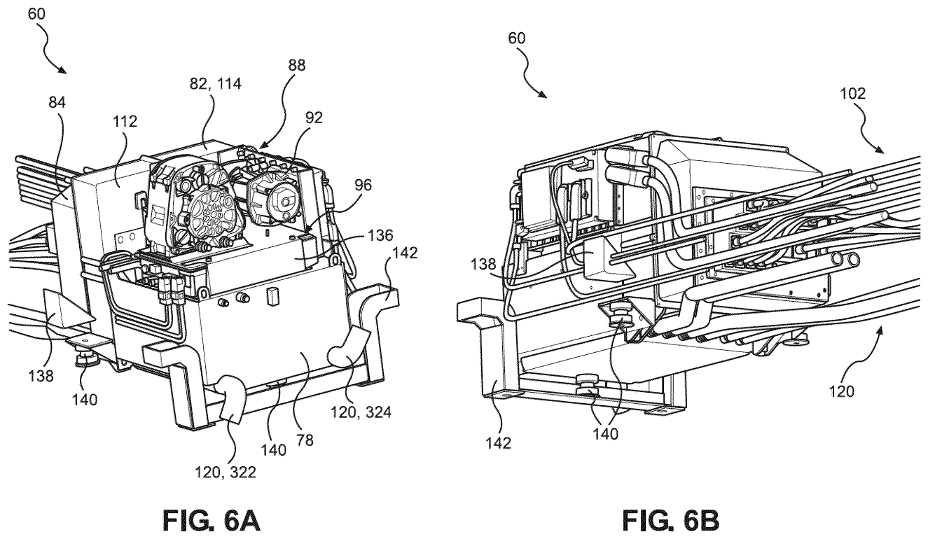

FIG. 5 shows a rear-perspective view of the PCAS 60 according to one or more embodiments. FIG. 6A and FIG. 6B show a front-perspective view and a rear-perspective view of the PCAS 60 provided with a plurality of electrical lines and a plurality of fluid lines. The PCAS 60 includes a thermal management system (TMS) 78, a low-voltage power distribution unit (LVPDU) 88, a high-voltage power distribution unit (HVPDU) 86, a distribution assembly 82, a core assembly 84, and one or more vehicle accessories that may include an onboard charger 96, a power steering pump 92, and an air compressor 94.

As will be described herein, the PCAS 60 may be configured with a modular design adapted for use in various types of vehicles. Additionally or alternatively, the modular design of the PCAS may be configured to be arranged within the various vehicles so that one or more portions of the PCAS may be accessed to enable servicing of the PCAS 60. The HVPDU 86 may be arranged to face the ROV of the vehicle 68. The HVPDU 86 may include a number of high-voltage receptacles 104. Some of the high-voltage receptacles 104 may be arranged on a stepped structure 106 to enable arrangement of wires to accommodate connecting one or more ESS modules 34 (e.g., eight strings of batteries) to the high-voltage receptacles 104. A portion of the HVPDU 86 may be disposed within the core assembly 84 and a cover portion 108 of the HVPDU 86 may be fixed to a rear portion or wall 100 of the core assembly 84.

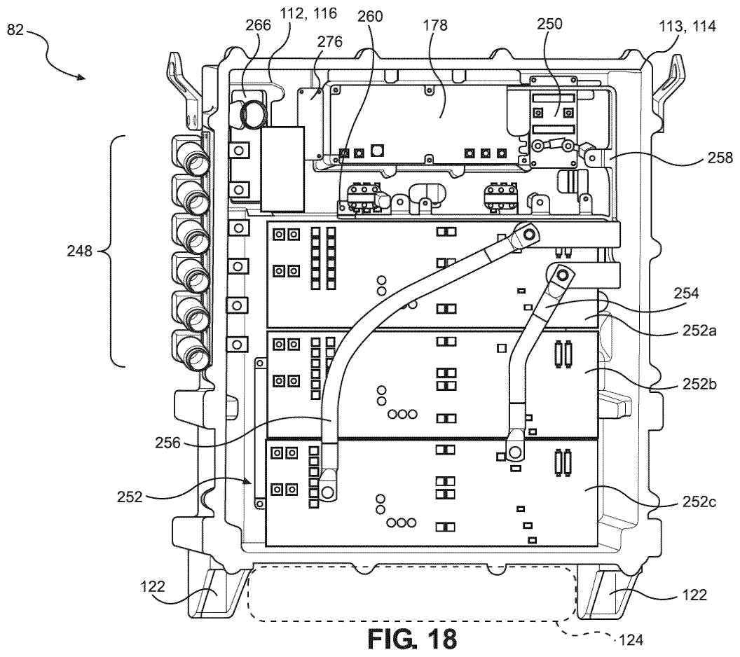

The core assembly 84 includes the rear wall 100 and a front wall 110 that may be fixed to (e.g., fastened) to the distribution assembly 82. An upper portion of the front wall 110 includes an inclined surface 98 that may be disposed beneath and substantially parallel to one or more portions of the firewall 76. The arrangement of the core assembly 84 with respect to the firewall 76 may enable access to the HV receptacles 104 to permit relatively easy serviceability. The distribution assembly 82 may include a base 112 and one or more peripheral walls 114 that may extend (e.g., away from the base towards the core assembly 84, in a direction parallel to the longitudinal axis LA of the vehicle 68, or in a direction substantially orthogonal to the longitudinal axis LA) from the base 112 to form a receptacle 116 (FIG. 18). The base 112 of the distribution assembly 82 may also be referred to as a rear wall and may be directly connected to one or more portions (e.g., a rear wall 118) of the TMS housing 80. The front wall 110 of the core assembly 84 may be referred to as a cover configured to cover the receptacle 116 (FIG. 18) of the distribution assembly 82.

A portion (e.g., bottom portion) of the distribution assembly 82 may include a pair of lower flanges 122 that may be fixed to one or more portions (e.g., bottom portion) of the TMS housing 80 by one or more fasteners or other suitable means. The pair of flanges and one or more portions of the front wall or cover 110 may define a recess 124 (FIG. 18) that may be disposed between a pair of lower flanges 122 of the distribution assembly 82. The recess 124 may enable access to one or more fluid connections 126 configured to receive or connect with one or more fluid lines 120. As an example, the one or more fluid lines 120 may be disposed beneath and extend parallel to the one or more HV lines 102.

As described herein, the LVPDU 88 and the HVPDU 86 are separate components to enable independent serviceability of the LVPDU 88 and the HVPDU 86. The LVPDU 88 may include a case 132 and an access cover 134 which may be removed to access the interior case 132. The LVPDU 88 may be disposed above the TMS housing 80 and forward of the distribution assembly 82 so that the LVPDU 88 may be accessed for service (e.g., from a side of the vehicle 68). The LVPDU may include one or more controllers and control boards configured to supply low-voltage electrical power and to control to one or more components of the vehicle and the PCAS 60. The LVPDU 88 may be fixed (e.g., directly connected) to the rear wall 112 of the distribution assembly 82 and a LVPDU support bracket 130 may be fixed to the LVDPU case 132 and the TMS housing 80.

The onboard charger 96 may be disposed on top of the TMS housing 80 and adjacent to the LVPDU 88. The onboard charger 96 may be electrically connected to one or more electrical components of the distribution assembly 82 such as a DC/DC converter that may be configured to regulate the flow of energy into the ESS modules 34 (e.g., vehicle battery packs) as they are recharged while accounting for rising internal resistance of the batteries as their state of charge increases. The onboard charger 96 eliminates the need for external battery chargers and may save tens of thousands of dollars per vehicle in infrastructure costs and simplify the recharging process. A cover such as an onboard charger cover 136 may be fixed to the TMS housing 80 and enclose one or more portions of the onboard charger 96. The steering pump 92 and the air compressor 94 may each be fixed to the cover 136 of the onboard charger 96.

The PCAS 60 may be supported and attached to the vehicle by one or mounting brackets and one or more isolators. The mounting brackets may include a front mount 142 and a one or more peripheral mounts 138. The front mount 142 may have a U-shaped configuration configured to receive and support the TMS housing 80 and the peripheral mounts 138 may be fixed to sides of the PCAS 60. In one or more embodiments, one or more electrical lines may extend through the peripheral mounts 138.

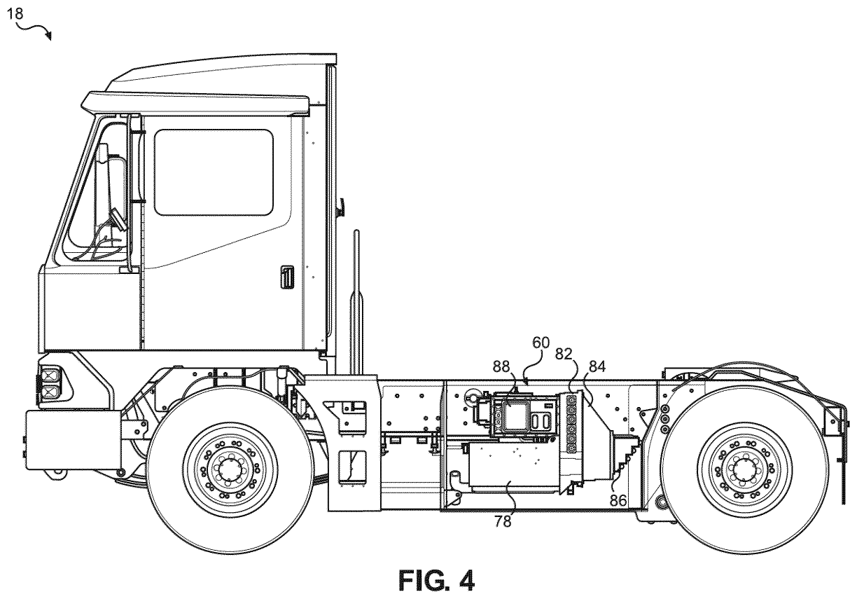

FIG. 4 shows a side-plan view of a frame rail wide terminal tractor FCEV—PCAS side mount 18 provided with the PCAS 60. The TMS 78 of PCAS 60 may be disposed near the front of the vehicle and the HVPDU 86 may be disposed near the rear of the vehicle 18. The LVPDU 88 may be disposed on a side of the vehicle 18 to enable access to the LVPDU 88.

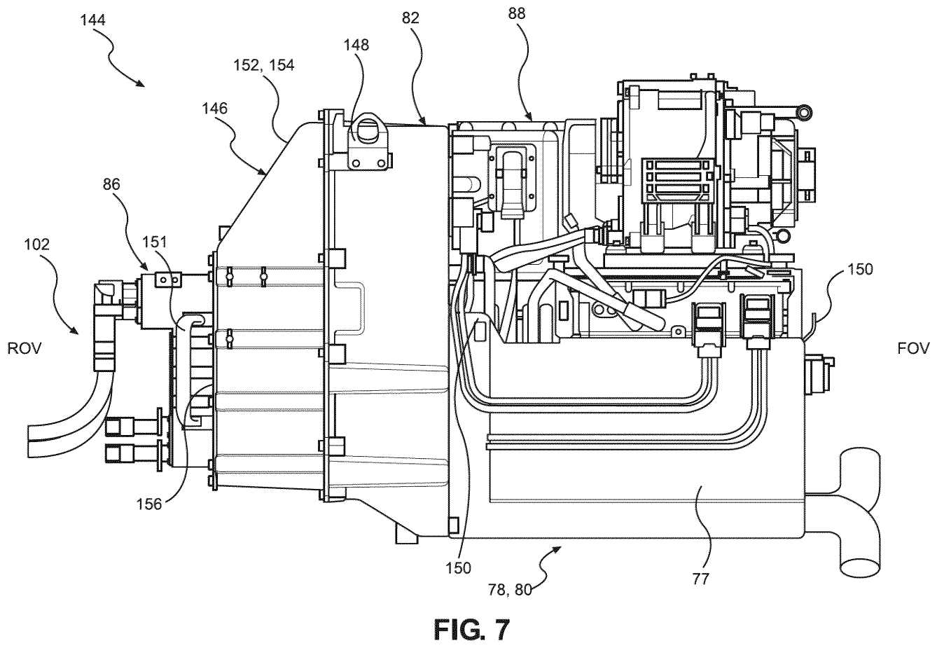

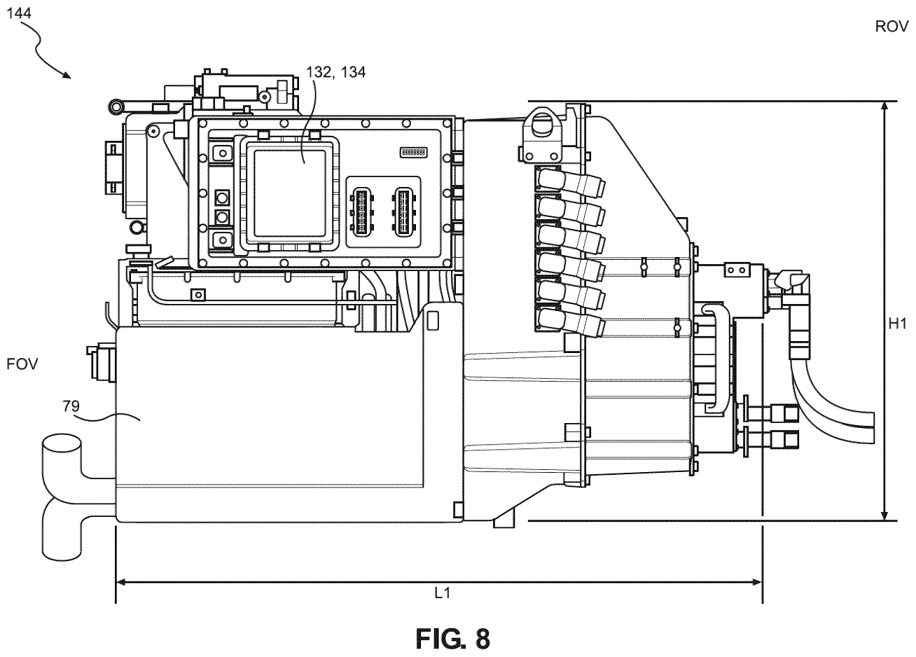

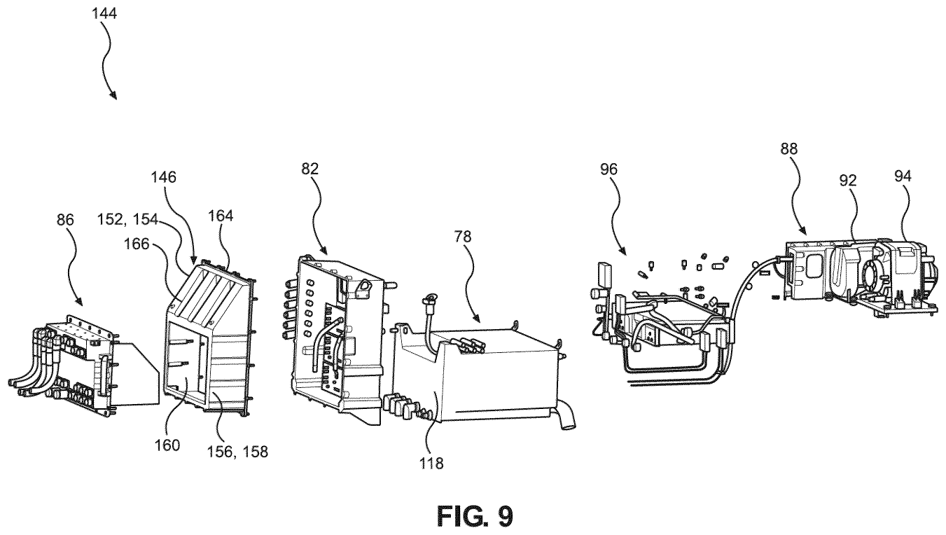

FIG. 7 and FIG. 8 each show side plan elevation views of another PCAS assembly 148 according to one or more embodiments. FIG. 9 shows a perspective-exploded view of the PCAS assembly 148. The core assembly 146 includes a rear wall 156, a front wall 164, an upper portion 152, and a bottom portion 158. A portion of the rear wall 156 (e.g., the bottom portion 158) may define one or more aperture 160 configured to receive or house one or more portions of the HVPDU 86. The upper portion 152 may include an inclined surface 154 that may extend from the bottom portion of the rear wall 156 to the front wall 164 of the core assembly. The rear wall 164 may be configured to close off the distribution assembly 72. As an example, the inclined surface may define one or more recesses or channels 166 that may be configured to reduce weight, route debris or water away from the distribution assembly 82, or both.

As described herein, the components of PCAS 144 are arranged to provide a relatively compact design configured for use in a wide range of vehicles with varying packaging envelopes. The overall length L1 of the PCAS 144 may range between 800 mm and 1,200 mm, the height H1 may range between 480 mm to 720 mm, and the width W1 may range between 480 mm to 720 mm.

In one or more embodiments, the PCAS 144 may include one or more brackets configured for positioning the PCAS 144 or components thereof during installation of the PCAS 144 to a vehicle or during assembly of the PCAS 144. As an example, the HVPDU 86 may include a handle 151 configured for an operator or a device (e.g., robotic arm) to grasp and manipulate the HVPDU 86. The distribution assembly 82 may include one or more brackets 148 provided with apertures configured to receive a hook or other device to enable lifting and positioning of the distribution assembly 82 and/or the PCAS 144. The TMS 78 may include one or more brackets 150 that may be integrally formed with the TMS housing 80.

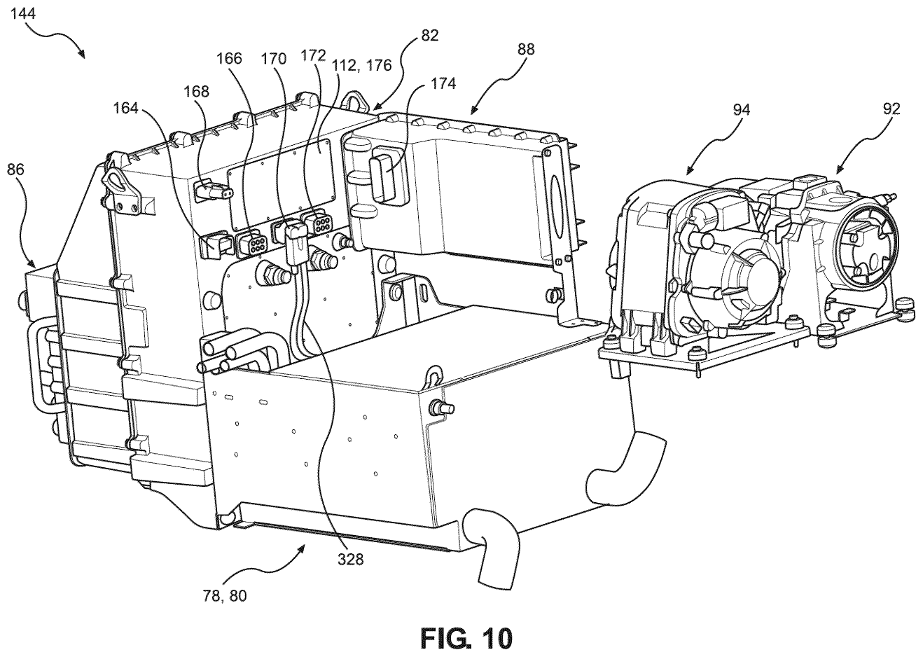

FIG. 10 illustrates a rear-perspective-partial-exploded view of the PCAS 144. For purposes of clarity, the onboard charger is not illustrated. One or more electric connections may be provided within an area disposed above the housing 80 of the TMS 78 and partially enclosed by base 112 of the distribution assembly 82 and the LVPDU 88. The one or more electrical connections may include an onboard-charger HV output receptacle 164, an accessory HV output receptacle 166, a measuring port 168, a TMS HV output receptacle 170, a HV output auxiliary receptacle 172 may extend from the base 112 of the distribution assembly 82. A low-voltage (LV) harness receptacle 174 may extend from the LVPDU 88. The measuring port 168 may be electrically connected to one or more electrical components (e.g., a limit resistor board 250 shown in FIG. 18) configured to receive a measurement device (e.g., a voltmeter) to measure voltage of the PCAS 144 prior to servicing the PCAS 144.

The TMS HV output receptacle 170 may provide HV power from the distribution assembly 82 to one or more components of the TMS 80 (e.g., a PTC heater and AC compressor). The core module housing 66 may include one or more vents such as a gore vent 172 configured to relieve pressure within one or more coolant passages formed in the core module housing 66.

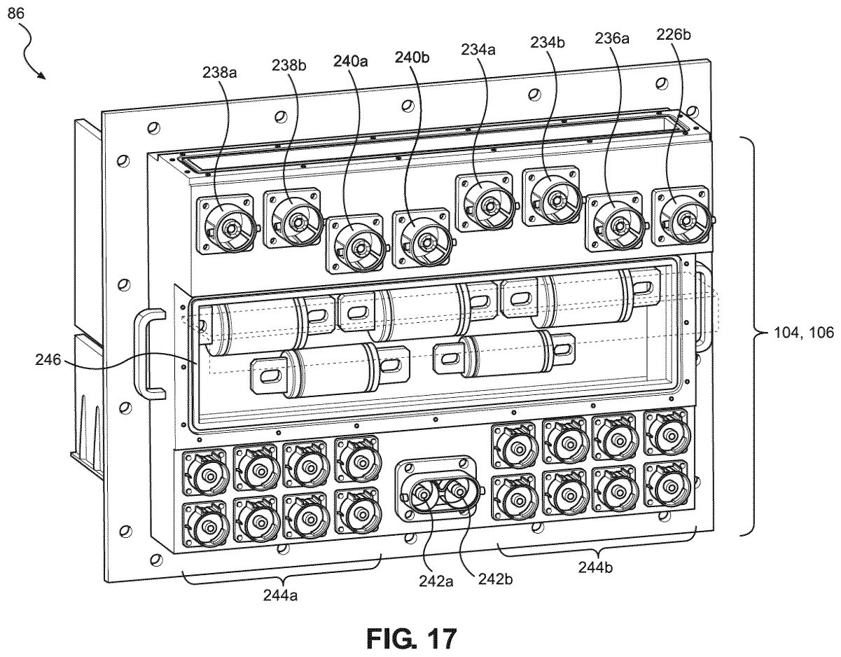

The base 112 of the distribution assembly 82 may define one or more openings configured to provide access to components disposed in the distribution assembly 82. As an example, fuse printed circuit board (PCB) 178 (FIG. 17) may be disposed within the distribution housing 82 and an access plate or cover 176 may be fixed to the base 112 of the distribution housing 82 to enable access to the fuse PCB 178.

The PCAS 144 may include one or more air compressors such as a brake air compressor 94 configured to provide pressurized air for operation of the vehicle brakes. An electric power steering pump 92 may be disposed above the TMS and adjacent to the brake air compressor 94. The electric power steering pump 92 may be configured to provide pressurized fluid (e.g., power steering fluid) to the vehicle's steering system. The brake air compressor 94, the power steering pump 92, or both may include a motor inverter configured to change direct current to alternating current. Integrating an inverter into individual components, such as the brake air compressor 94 and the power steering pump 92, as opposed to providing one inverter for all such components, eliminates the need for a larger inverter and may reduce the overall size of the PCAS 144.

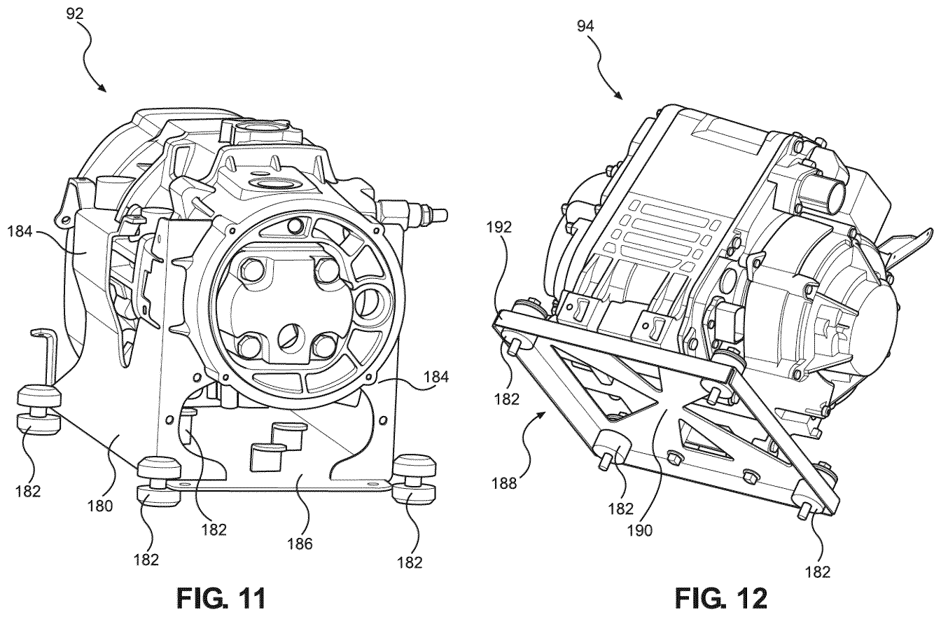

FIG. 11 illustrates a perspective view of the power steering pump 92 and a steering pump mounting bracket 180 fixed to the steering pump 92. The pump mounting bracket 180 may include one or more stanchions 184 that may extend from a base 186 of the pump mounting bracket 180. The mounting bracket 184 may be configured for attachment to the TMS housing 80 of the TMS 78. The one or more stanchions 184 may be configured so that the steering pump 92 is spaced apart from a base 186 of the mounting bracket 180. The spacing may be configured to enable acoustic decoupling of the power steering motor 92 from the TMS module 78. One or more component isolators may be fixed to the base 186 of the mounting bracket 180 to further facilitate the acoustic decoupling of the power steering pump 92 from the other portions of the PCAS 144.

FIG. 12 illustrates a perspective view of the brake air compressor 94 and a brake air compressor bracket 188 fixed to the air compressor 94. The brake compressor bracket 188 may include a cross-brace 190 and one or more peripheral walls 192 that may surround and connect to the cross-brace 190. One or more component isolators 182 may be fixed to end portions of the cross-brace and disposed within the one or more peripheral walls 192.

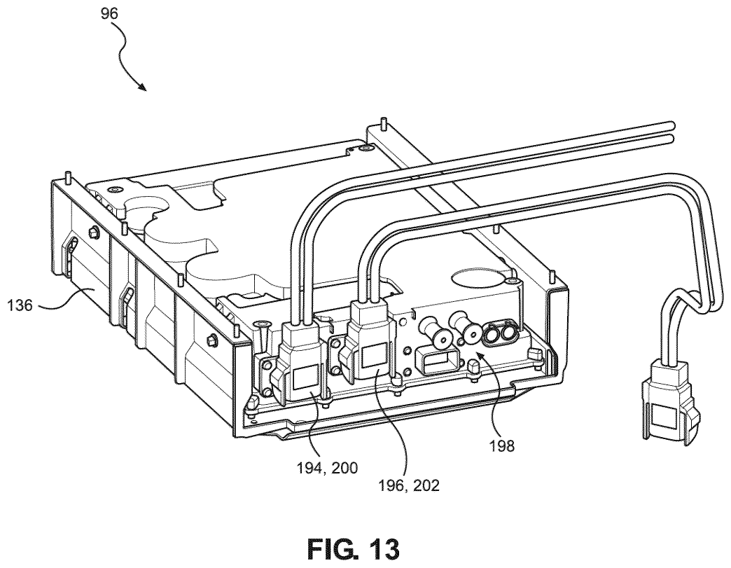

FIG. 13 shows a bottom perspective view of the onboard charger 96 according to one or more embodiments. One or more sides of the onboard charger 96 may include one or more electrical receptacles configured to receive one or more electric lines to enable connection to components of the vehicle and the PCAS 144. The one or more receptacles may include a battery charger receptacle 198, a HV input AC/DC receptacle 194, and a HV DC output receptacle 196. The HV input AC/DC receptacle may be connected to a HV input AD/DC cable from an electric vehicle supply equipment (EVSE) component such as an EV charger. The HV DC output receptacle may be connected to an HV DC output cable 202 that may be connected to one or more of the ESS modules 34.

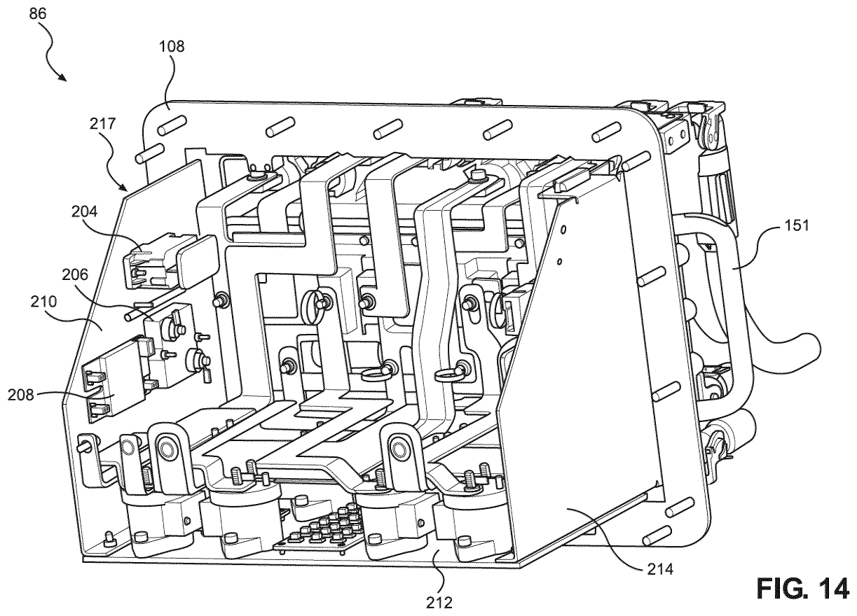

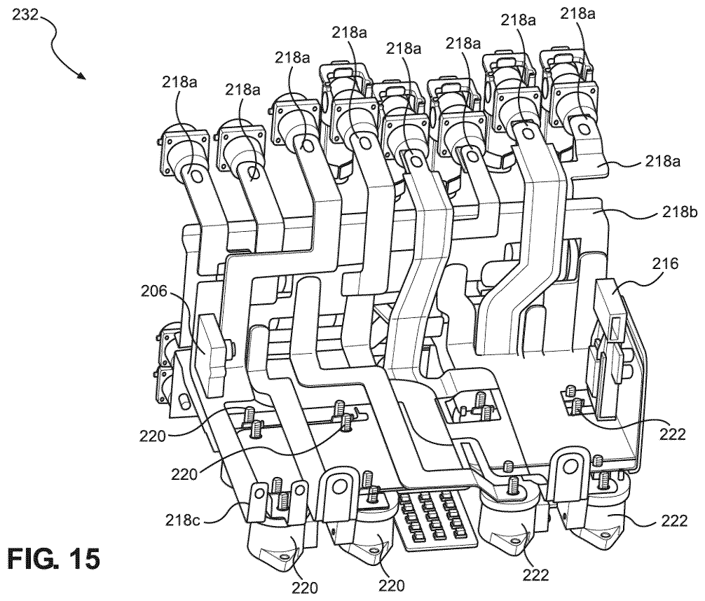

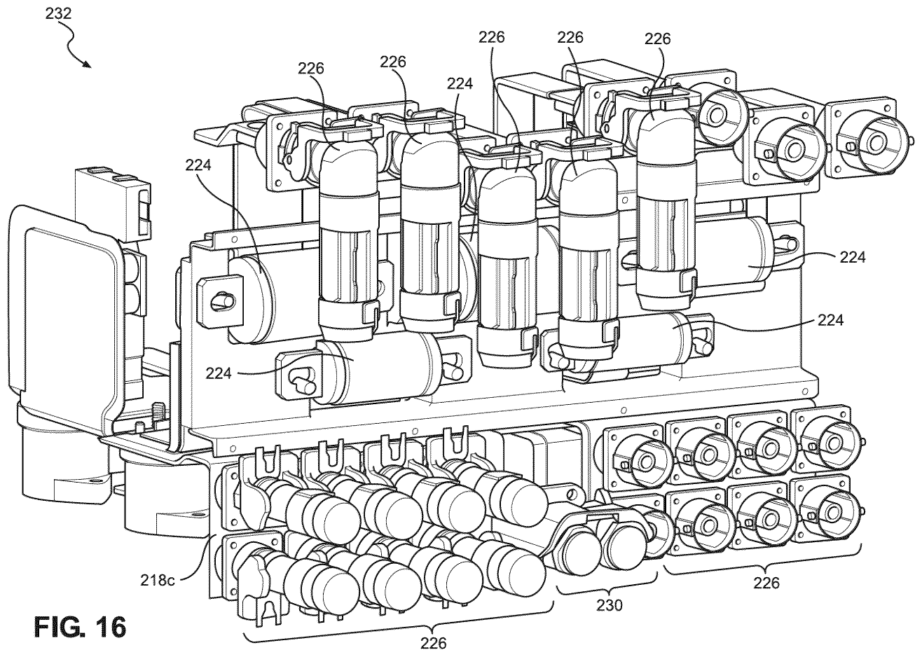

FIG. 14 shows a front-perspective view of a HV junction box 217 of the HVPDU 86 according to one or more embodiments. FIG. 15 shows a rear perspective view of one or more junction box connectors 232 and FIG. 16 shows a front-perspective view of the one or more junction box connectors 232. The HV junction box 217 may form a portion of the HVPDU 86 and the junction box 217 may include a first sidewall 210, a second sidewall 214, and a base 212 that may each extend from the cover 108 of the HVPDU 86. The junction box 217 may be configured to house a one or more electrical components and one or more junction box connectors 232.

The one or more electrical components may include a pre-charge contactor 204, a pre-charge circuit 206, and a ground fault sensor 208 that may each be fixed to the first sidewall 210 of the junction box 217. The pre-charge circuit 206 may be configured to ensure inrush current is below a positive contactor threshold to alter the current of the HV bus to a safe delta prior to closing contactors (e.g., pre-charge contactor 204) to enable HV power distribution. The pre-charge circuit 206 may include a pre-charge resistor that may be configured to consume power de-rate current prior to connecting to pre-charge contactor 204 as part of a contactor control sequence during a HV wake up operation. The ground fault sensor 208 may be configured to detect a ground fault within the HVPDU 86 to disconnect power and prevent injury or damage to the PCAS 144.

The junction box connectors 232 may include one or more laminated bus-bars 218, one or more fuses 224 (e.g., large profile fuses), a first number of single pole contactors 226, a second number of single pole contactors 228, a first number of HV contactors 220, a second number of HV contactors 222 and one or more dual pole contactors 230. The laminated bus-bars 218 may be arranged in one or more layers 218a-218c to facilitate electric connection of the single pole contactors 220, 222, dual pole contactors 230, and the fuses 224. The one or more fuses 224 may be round body fast acting fuses configured to protect the ESS modules 34, a drive inverter, and HV bi-directional power ports.

As an example, the laminated bus-bars 218 may include one or more bent portions to enable a relatively compact arrangement of the electric connections and the stepped structure 106 of the HV receptacles 104 (FIG. 5). The first layer 218a may be directly connected to the first number of single pole contactors 226, the second layer 218b may be directly connected to each of the fuses 224, and the third layer 218c may be directly connected to the second number of single pole contactors 226. Each of the layers 218a-218c may be directly connected to the first number of HV contactor assemblies 220 and the second number of HV contactor assemblies 222.

FIG. 17 illustrates a rear-view of the HVPDU 86 provided with the HV receptacles 104 and the stepped structure 106. The HV 104 receptacles may include a number of positive and negative ports, and a fuse access panel 246. The fuse access panel 246 may be selectively removable to provide access to the one or more fuses 224 disposed in the HVPDU junction box 217. A first pair of ports including a positive first port 234a and a negative first port 234b and a second pair of ports including a positive second port 236a and a negative second port 236b. The first pair of ports and the second pair of ports may each be collectively configured to supply a continuous current at 500 amperes (A) to one or more vehicle loads (e.g., DC fast charger or fuel cell) via one or more contactors 220, 222, fuses 224, or both.

A third pair of ports include a positive third port 238a and a negative third port 238b that may be configured to supply a continuous current of 500 A to a drive inverter of the vehicle. A fourth pair of ports include a positive fourth port 240a and a negative fourth port 240b configured to supply current to at least one of the ePTO 54 (e.g., 200 A), a brake resistor (e.g., 300 A), and the drive inverter (e.g., 400 A) via one or more of the fuses 224. The fifth pair of ports include a positive fifth port 242a and a negative fifth port 242b configured to supply current to a fifth wheel (e.g., 100 A), the ePTO 54 (e.g., 200 A), and the brake resistor (e.g., 300 A) via one or more of the fuses 224. The first through fifth pairs of ports 234-242 may each be configured to supply the amperes disclosed above at a nominal voltage of 700 V. It should be understood that the values described above are approximations and may be adjusted as required. The one or more ports includes a plurality of positive ESS ports 244a and a plurality of plurality of negative ports 244b may be collectively configured to supply and receive electric power from one or more of the ESS modules 34.

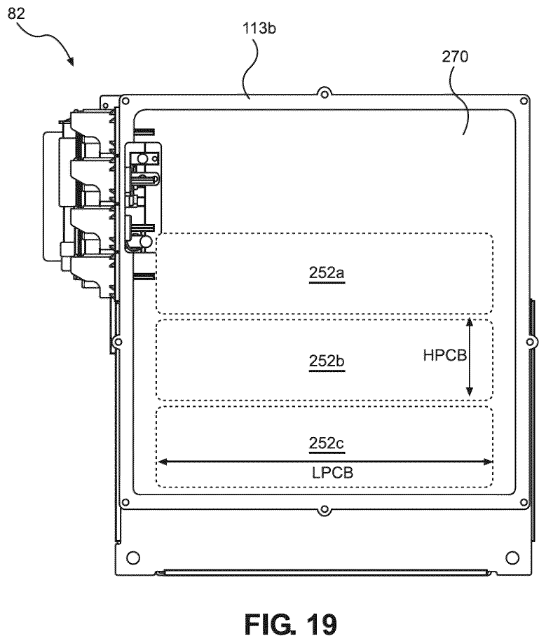

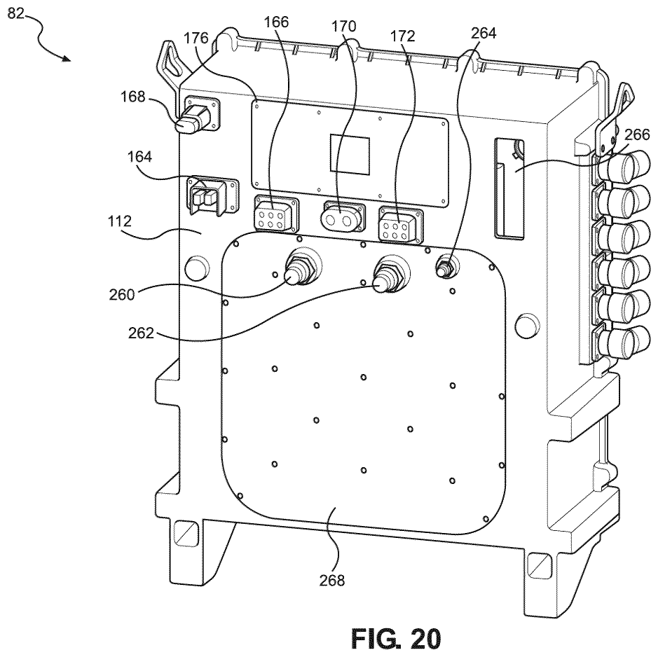

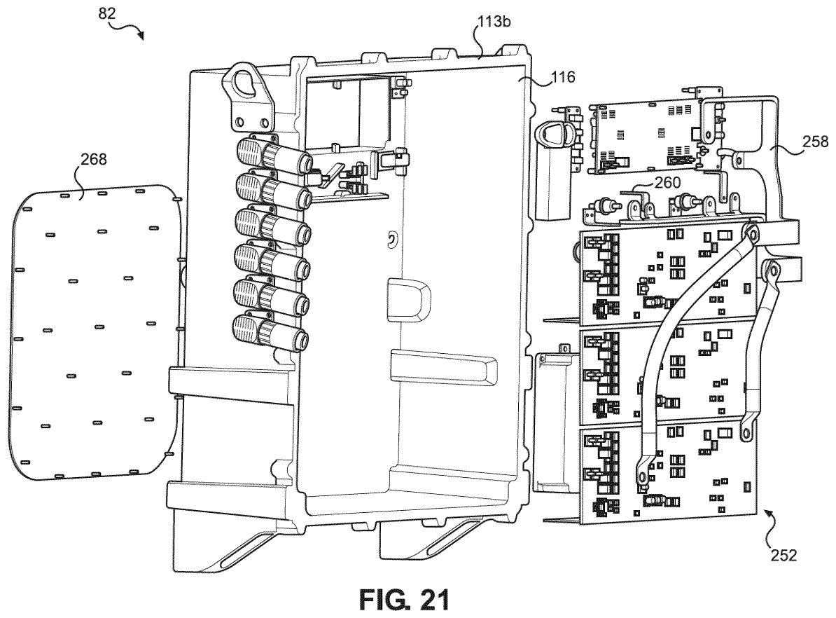

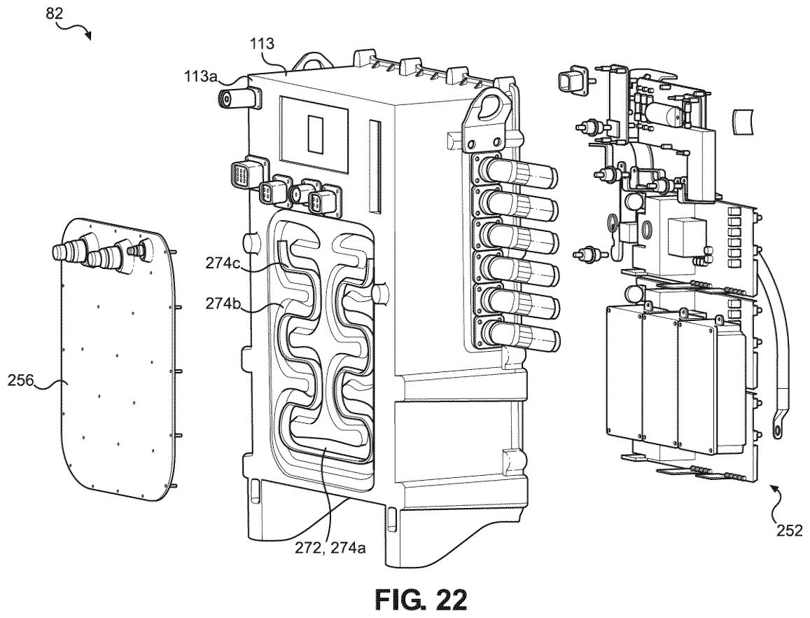

FIG. 18 illustrates a plan view of the distribution assembly 82. The distribution assembly 82 may include a distribution housing 113 that includes the one or more peripheral walls 114 each extending from the base 112 and collectively forming the receptacle 116 of the distribution housing 113. FIG. 19 illustrates a plan view of the distribution assembly 82 provided with a distribution assembly cover 270. FIG. 20 and FIG. 21 each show perspective-exploded views of the distribution assembly 82.

In one or more embodiments, the distribution housing 113 that may be formed by casting and comprise one or more alloys (e.g., aluminum, magnesium, or other suitable material) and include the one or more peripheral walls 114 that may extend from the base 112 of the distribution housing 113. The distribution housing 113 may include a first side 113a that may be directly attached to the TMS housing 80 (e.g., FIG. 10) and a second side 113b that may define an opening of the receptacle 116. As an example, the second side 113b may include a cover 270 that, when assembled, may cover the receptacle 116. The receptacle 116 may be configured to receive one or more electric components including a high-voltage interlock loop (HVIL) PCB 276, a DC-DC electronic module 252, one or more busbars, 258, 260, the fuse PCB 178, and a limit resistor board 250.

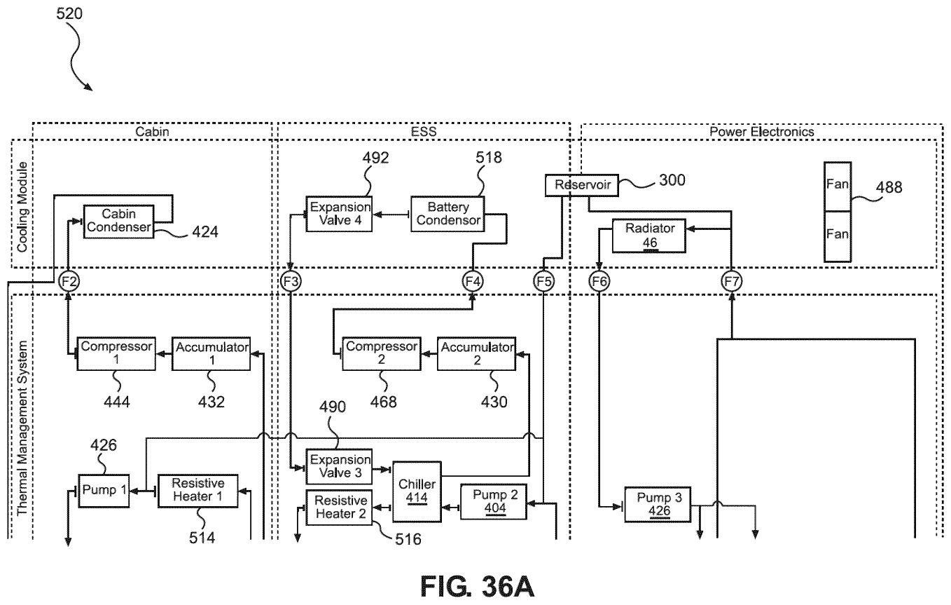

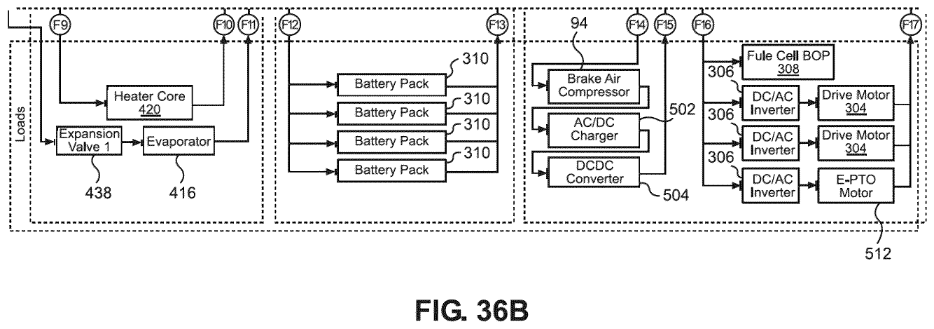

One or more third single pole contactors 248 may be fixed to the one or more peripheral walls and extend into the receptacle 116 to enable connection between the distribution assembly 82 and one or more vehicle loads (e.g., DC fast charger or fuel cell). The base 112 may define an aperture such as an LVPDU opening 266 that may be configured to receive one or more connectors of the LVPDU 88 to enable connection to a system control module 278 via an adapter board 280 (FIG. 36).

One or more busbars may be fixed to one or more inner walls or the base 112 of the distribution housing 113. As an example, first and second busbars 258, 260 may be disposed within the receptacle 116, the first busbar 254 may be connected to a positive HV bus cable 256 and a negative HV bus cable 254 configured for connection with the HV PDU 86. The second busbar 260 may be connected to the onboard-charger HV output receptacle 164, the accessory HV output receptacle 166, the TMS HV output receptacle 170, and the HV output auxiliary receptacle 172.

The DC-DC control module 252 may be configured to convert high voltage from one or more batteries or strings of batteries to a lower voltage (e.g., 12V or 24V) to enable powering of one or more components such as cabin accessories. The DC-DC electronic control module 252 may include one or more electronic circuits (e.g., one or more printed circuit boards 252a, 252b, 252c), an electromechanical device, or both that converts a source of direct current from one voltage level to another. The circuit boards 252a, 252b, 252c may each include a height HPCB and a length PCB. The height HPCB may be in the range of 75 mm to 125 mm and the length LPCB may range between 350 mm to 490 mm. Each of the circuit boards 252a, 252b, 252c may be spaced apart from an edge of the distribution assembly cover 270 by a first gap G that may have a range between 21 mm and 35 mm.

The DC-DC control module 252 may generate a significant amount of heat during operation and the distribution assembly 82 may include one or more heat exchangers that may be configured to capture the heat generated by the DC-DC control module 252 during operation. The distribution assembly 82 may be fluidly connected to the TMS 80 and may include a coolant manifold 272 provided with one or more coolant channels or passages 274a, 274b, 274c in which coolant may be routed to capture or provide heat to and from the DC/DC converter 102. In one or more embodiments, the coolant channels 274a, 274b, 274c may each include a pair of U-shaped passages that oppose one another and that are formed or defined by the base 112 of the distribution housing 113.

As an example, the coolant channels 274a, 274b, 274c may be closed off (e.g., sealed) by a coolant cover 268 configured to be fixed to the base 112 (e.g., first side 113a of the distribution housing 113a). The coolant cover may include one or more fluid receptacles such as a first fluid coolant port 260, a second coolant port 262, and a breather port 264. The breather port 264 may be formed by one or more vents such as a gore vent each configured to relieve pressure within the one or more coolant channels 274a, 274b, 274c. The first and second coolant ports 262, 264 may be collectively configured to receive and expel coolant to and from the distribution assembly.

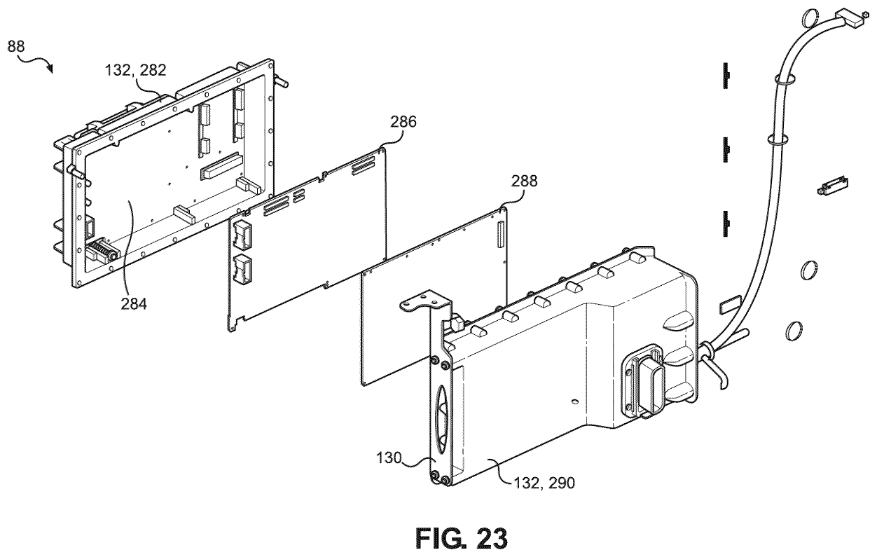

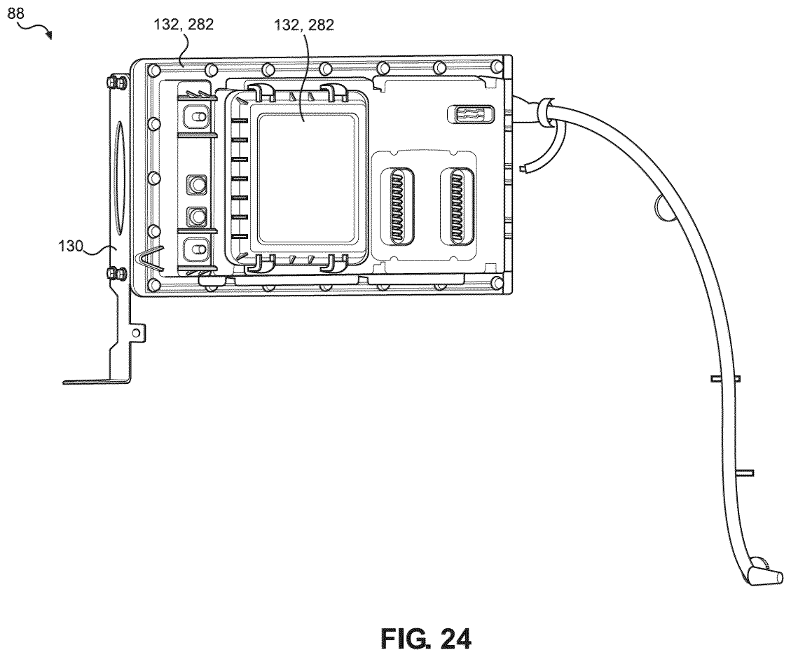

FIG. 23 and FIG. 24 each show perspective views of the LVPDU 88 according to one or more embodiments. The LVPDU 88 may include the LVPDU case 132 that may include a first half 282 and a second half 290 that may be attached to one another by one or more fasteners (not illustrated) or another suitable means. The first half 282 may include the access cover 134 and removal of the access cover 134 may provide access to a LVPDU PCB 284 disposed within the first half 282 of the LVPDU case 132. The LVPDU case 132 may also be configured to house a LVPDU adapter board 286 and a LVPDU control board 288. As will be described in greater detail below, LVPDU 88 may be configured to provide LV power to one or more components of the PCAS 144 and the vehicle.

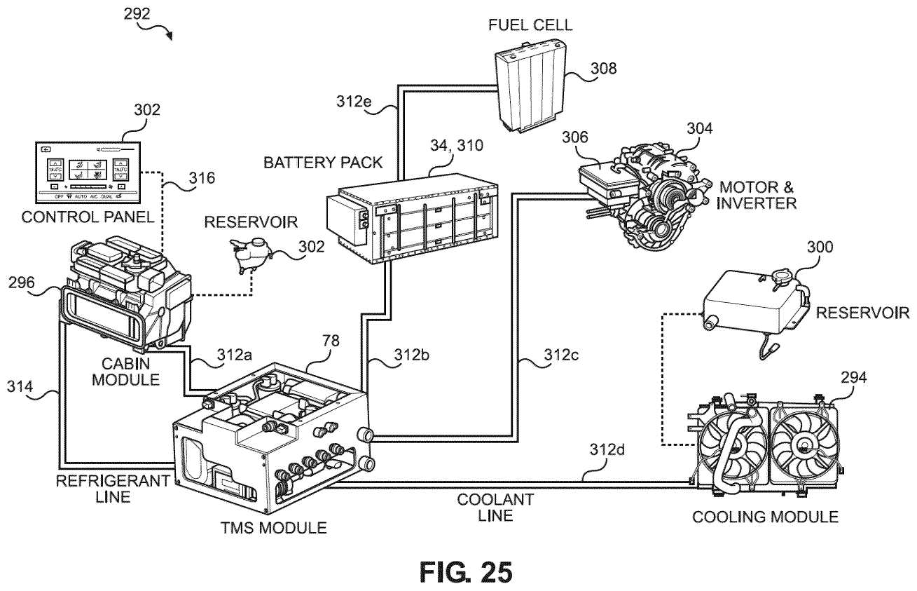

FIG. 25 shows an exemplary schematic diagram of a vehicle thermal management architecture 292. One or more coolant lines may fluidly connect the TMS module 78 to one or more vehicle components, including but not limited to a cooling module 294, a vehicle drive motor 304 and inverter 306, one or more ESS modules 34 (e.g., battery packs 310), a fuel cell stack 308, and a cabin module 296. The cooling module may be fluidly and electrically connected to the TMS 78 by one or more coolant lines 312d (e.g., supply and return) and a cooling module reservoir 300 configured to receive or provide excess coolant, as required. The cabin module 296 may be connected to the TMS 78 by one or more refrigerant lines 314 and one or more coolant lines 312a. The TMS 78 may be configured to route coolant and refrigerant (e.g., via one or more compressors or pumps) to the cabin module 296 which may include one or more heat exchangers and fans collectively configured to cooperate with one another to regulate the temperature of the vehicle cabin. The control panel 302 may be electrically connected to the cabin module to enable a user or operator to adjust heating and cooling of the vehicle cabin. The TMS 78 may also be fluidly connected to the fuel cell stack 308 by or one or more coolant lines 312e and the drive motor 304 and drive inverter 306 by one or more coolant lines 312c.

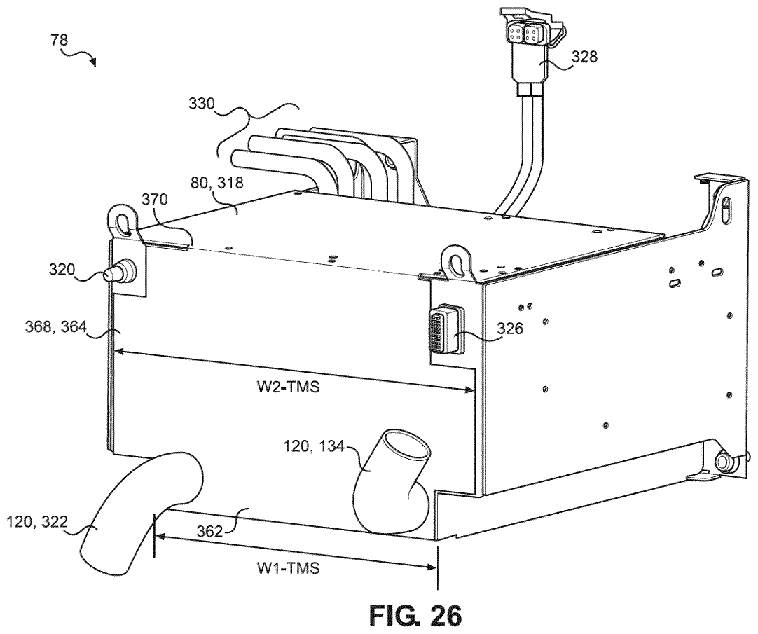

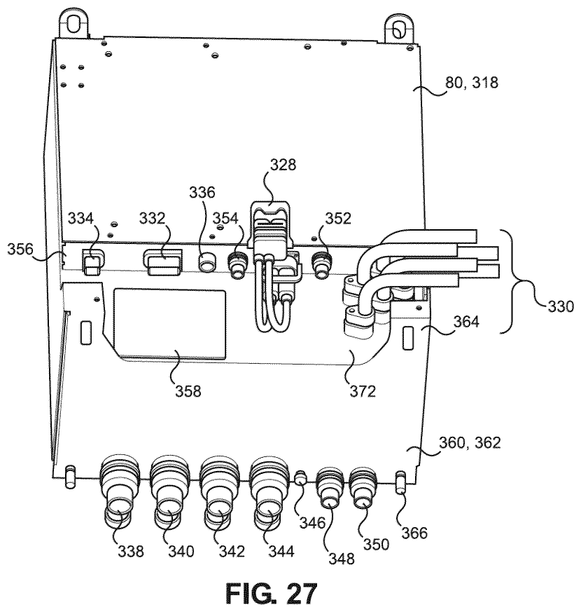

FIG. 26 shows a front-perspective view of the TMS 78 and FIG. 27 shows a rear-perspective view of the TMS 78 according to one or more embodiments. As described herein, the TMS 78 may be configured to provide structural support for other portions of the PCAS and alternatively or additionally, the TMS 78 may be configured to regulate the temperature of the PCAS 144 and one or more vehicle components. The TMS 78 includes the TMS housing 80 which may be comprised of one or more panels (e.g., metal stampings) including a first sidewall 77 and second sidewall 79 (FIGS. 8-9) that collectively enclose the components of the TMS 78.

The TMS housing 80 may include an upper region 364, a lower region 362, as well as a front face 368 and an attachment face 360 that may oppose the front face 368. The lower region 362 is disposed below the upper region 364 and may have a width W1-TMS that may be less than a width W2-TMS of the upper region 364. The upper region 364 includes a coolant reservoir receptacle 320 configured to receive and/or expel coolant to and from a coolant reservoir may extend from the front face 368. The lower region 362 of the front face 368 includes one or more of the fluid lines 120 such as a coolant-radiator return 322 and a coolant-radiator supply 324 that may each be configured to receive and expel coolant to and from one or more vehicle heat exchangers (e.g., a radiator of the cooling module 294). The TMS 78 may be electrically connected to one or more of the vehicle heat exchangers (e.g., cooling module 294) by one or more cables received by a connector 326 that may be disposed on the front face 368 (e.g., a LV-2 connector). In one or more embodiments, the top wall 318 of the TMS housing 80 may be directly connected to a panel of the front face 368 by a bent portion 370.

The top of the TMS housing 80 may include one or more walls including a top wall 318, a vertical wall 356, and a lower top wall 358 that may be arranged in a stepped configuration. The top wall 318 may be spaced above the lower top wall 358 and the vertical wall 356 may extend between the top wall 318 and the lower top wall 358. As an example, the top wall 318 may be configured to support one or more vehicle accessories such as the onboard charger 96, the steering pump 92, and the air compressor 94 (e.g., FIG. 6A). The vertical wall 356 and the lower top wall 358 may be collectively configured to provide a space for one or more electrical connections and fluid connections and the electrical and fluid connections disposed within the space may be at least partially enclosed by sidewalls of the TMS housing 80.

A power module interface receptacle 334 and a LV power input receptacle 332 may each extend from the vertical wall 356. The power module interface receptacle 334 may be configured to receive one or more electric lines (e.g., a TMS HV output connector harness 328 shown in FIG. 10) electrically connected to the distribution assembly 82 and the LV power input receptacle may be configured to receive one or more electrical lines electrically connected to the LVPDU 88 to enable power and control of one or more low-voltage components of the TMS. An electrical bonding connection 354 may extend from the vertical wall 356 and the electrical bonding connection may be configured to connect the metal TMS housing 80 or other metal items not intended to carry electricity to one another to prevent arcing or electric shock.

A distribution-coolant return 354 and distribution-coolant supply 352 may each be provided on the vertical wall 356. The distribution-coolant return and supply connections 352, 354 may be collectively configured to route coolant to and from the distribution assembly 82 (e.g., first and second fluid ports 260, 262). One or more refrigerant supply and return lines 330 may extend from the lower top wall 358 to enable fluid connection to one or more vehicle heat exchangers (e.g., the cabin module 296, ESS modules 34).

In one or more embodiments, the widths of the upper region and the lower region of front face 360 may be substantially equal to one another. The upper region 364 of the attachment face 360 may include a recessed portion 366 that may enable access to the electrical and fluid connections 334, 336, 354, 352, 330 disposed either on the vertical wall 336 or the lower top wall 358. One or more fasteners such as a stud 366 may be extend from the attachment face 360 to enable attachment to the distribution housing 113. The lower region 362 of the attachment face 360 may include one or more fluid receptacles including a coolant-drive return 338, coolant-drive supply 340, coolant-battery supply 342, coolant-battery return 344, a refrigerant charge port 346, a coolant-heater core supply 348, and a coolant-heater core return 350.

The coolant-drive return and supply receptacles 338, 340 may be configured to route and receive fluid (e.g., coolant) to and from one or more drive components of the vehicle such as the drive inverter 306 and the drive motor 304. The coolant-battery supply and return 342, 344 may be configured to route and receive fluid (e.g., coolant) to and from one or more heat exchangers or ESS module 34 components such as the battery back 310, the fuel cell stack 308, a battery condenser and evaporator, a battery chiller and heater, the ePTO 54, and others. The a coolant-heater core supply and return 348, 350 may be configured to route and receive fluid (e.g., coolant) to and from one or more heat exchangers or components configured to regulate the temperature of the vehicle cabin.

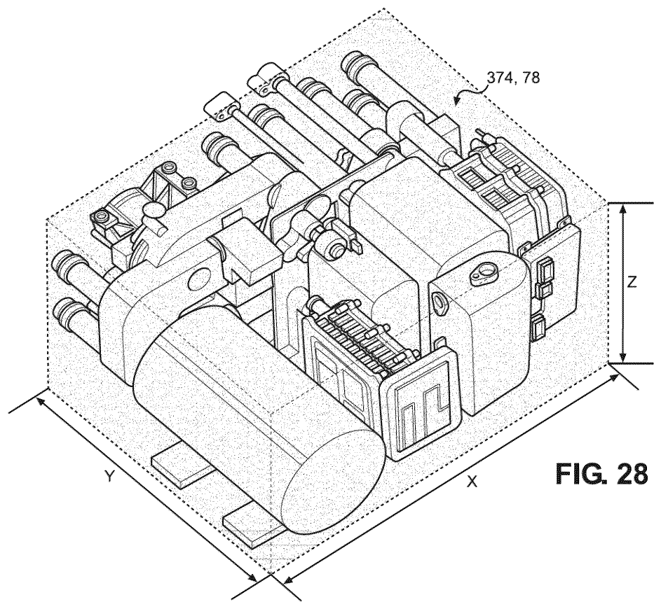

FIG. 28 shows a packaging window surrounding internal components 374 of the TMS 78 according to one or more embodiments. As described herein, the TMS 78 may be specifically designed to fit within a relatively small package size. For example, the height of the TMS 78 is represented by “Z” which may be approximately 320 mm, the length of the TMS 78 is represented by “X” which may be approximately 600 mm, and the width of the TMS 78 is represented by “Y” which may be approximately 500 mm. It should be understood that the width, height, and length dimensions described above may vary and are not intended to be limiting. To enable such a relatively small package size, the TMS 78 may integrate several components into a module. As an example, such components may include one more pumps 220, the battery chiller, refrigerant valve, the LCC, coolant valve, refrigerant manifold 222, coolant manifold 224, and the accumulator. In another embodiment, Z may be equal to 250 mm, X may be equal to 486 mm, and Y may be equal to 500 mm.

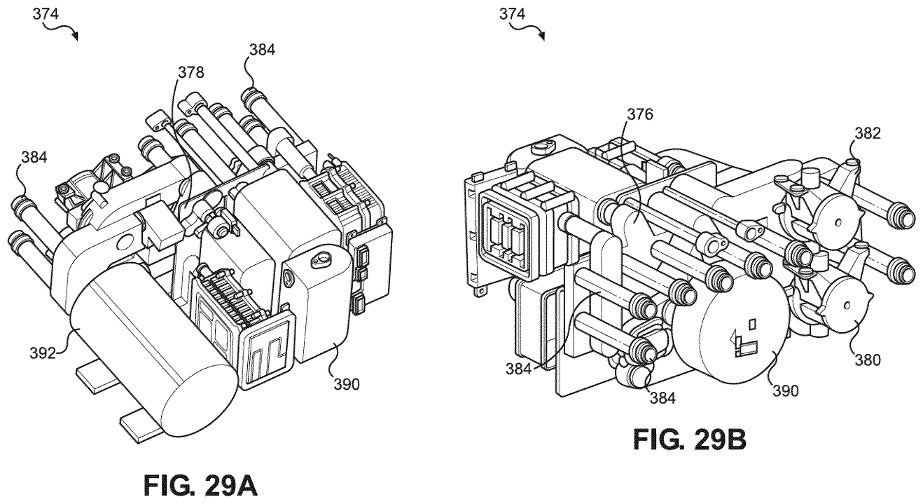

FIGS. 29A and 29B show first and second perspective views of the internal components 374 of the TMS 78. The TMS includes the coolant manifold 376 and the refrigerant manifold 378. The coolant manifold 376 includes one or more coolant inlets and outlets 384 that receive and route coolant receptacles 338-354. The refrigerant manifold is configured to receive refrigerant or another substance configured for heat transfer and route the refrigerant to the refrigerant supply and return lines 330. The TMS 78 may also include one or more pumps 380, 382, at least one compressor 392, and a condenser 390. The one or more pumps 380, 382 may be fixed to the coolant manifold 376.

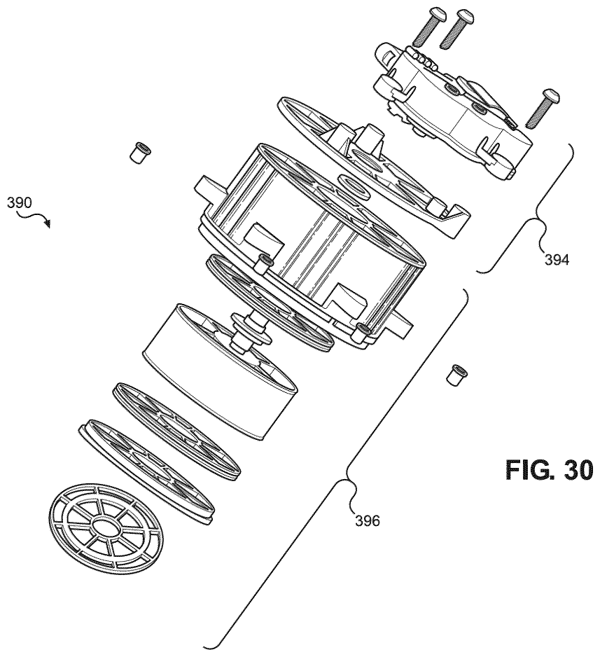

FIG. 30 shows an exploded view of the at least one valve 390 according to one or more embodiments. The valve 390 includes a valve core 394 and an actuator 396 (e.g., brushless motor) configured to actuate to open and close one or more of the nine valves.

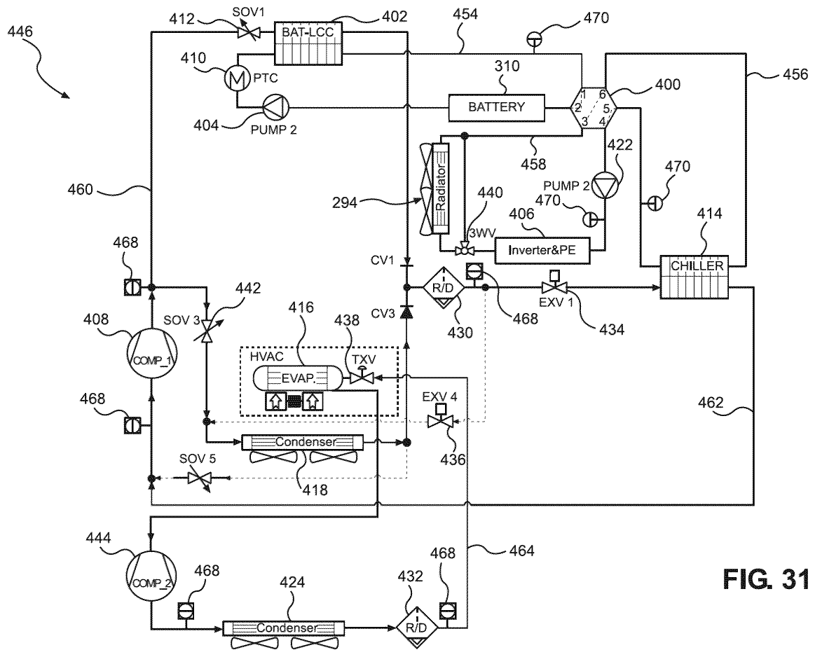

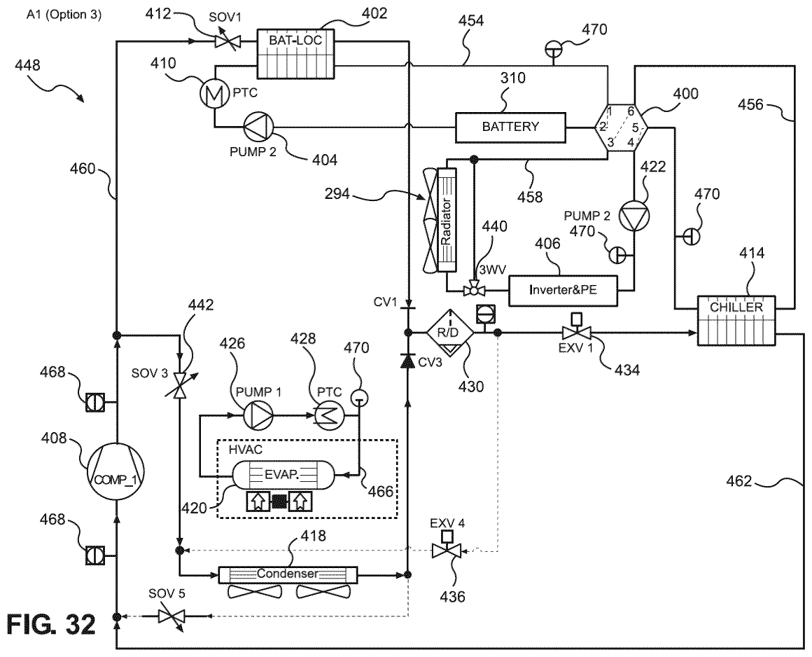

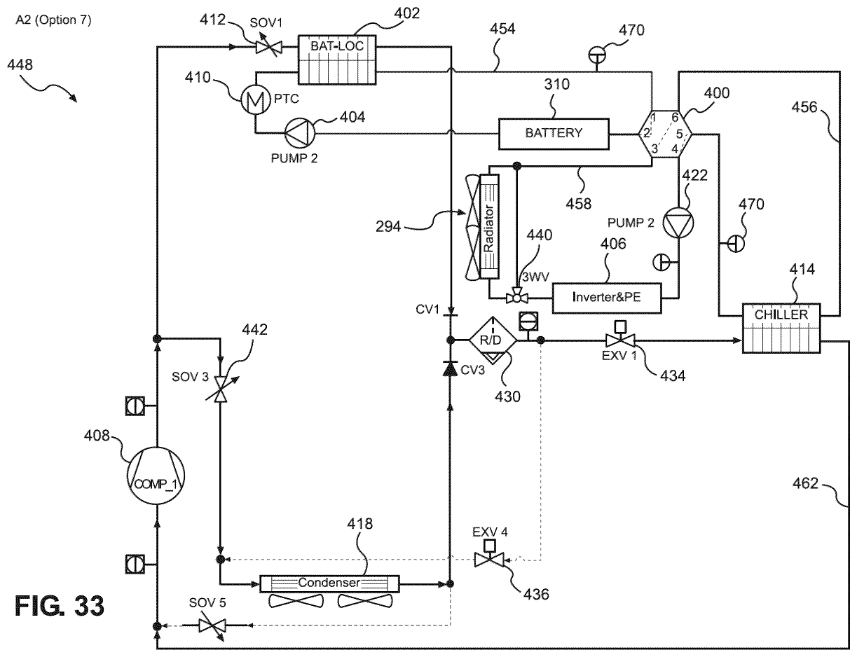

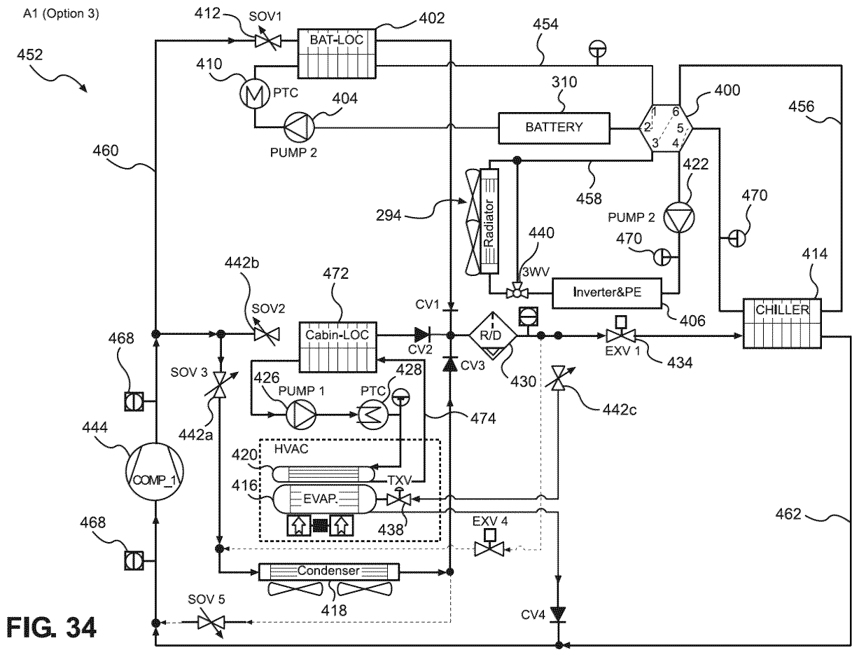

FIG. 31 through FIG. 34 show schematic fluid diagram of an exemplary vehicle which includes the TMS 78. FIG. 31 shows a first fluid schematic 452 provided with one or more coolant loops and one or more refrigerant loops. The coolant loops may include a first-coolant ESS loop 454, a second-coolant ESS loop 456, and a first-coolant vehicle drive and power electronics (PE) loop 458. The refrigerant loops may include a first refrigerant ESS loop 460, second refrigerant ESS loop 462, and a first refrigerant cabin loop 464. Refrigerant and coolant loops described with reference to the schematic 446 illustrated in FIG. 31 may be applicable to other schematics described herein.

The first schematic 446 may include a valve such as a six-way valve 400 that may be actuated and commanded by one or more controllers to selectively control the flow of fluid into and out of the six-way valve 400. The second-coolant-ESS loop 456 may extend from the valve 400 (e.g., outlet five) through a ESS heat exchanger such as a battery chiller and heater (BCH) 414 and return to the valve 400 so that the coolant, whether heated or cooled by the BCH 414, is provided to the battery pack 310 to enable temperature regulation of the battery pack 310.

The first coolant vehicle drive and PE loop 458 may extend from the valve 400 (e.g., outlet four) through a pump 422 configured to pump the coolant to one or more drive and electrical components such as a vehicle drive, inverter and PE 406. In one or more embodiments, the vehicle drive, inverter and PE may include but is not limited to one or more vehicle drive motors configured to power the vehicle, one or more drive inverters operatively connected to the drive motors, the ePTO 54, the steering pump 92, the air compressor 94, the onboard charger 96, and the distribution assembly 82. The coolant may be selectively routed through a three-way valve 440 to supply coolant from the inverter and PE 406 to the cooling module 294. It should be understood that the cooling module 294 may include one or more fans and one or more heat exchangers (e.g., a radiator).

The first coolant ESS loop 454 may extend from the valve 400 (e.g., outlet two) through the battery pack 310, into an ESS pump 404 configured to pump the coolant into a heater such as a positive temperature coefficient heater 410. After the coolant flows through the heater 410 it may then be routed to a battery heat exchanger such as a liquid cooled condenser 402.

The first refrigerant ESS loop 460 may include a shut-off valve 442 that may be selectively configured to allow refrigerant to flow from a first compressor 408 to a condenser 418. The refrigerant may be routed from the condenser 418 to the battery heat exchanger 402. Another shut-off valve 412 may be disposed between the first compressor 408 and the battery heat exchanger 402. Closing of shut-off valve 442 and opening of shut-off valve 412 may enable refrigerant to be routed to from the compressor 408, through the battery heat exchanger 402, and to the condenser 418.

The second refrigerant ESS 462 may include the first compressor 408 configured to route refrigerant through the condenser 418, to an accumulator 430. The refrigerant may flow from the accumulator 430 to an electronic expansion valve 434 that may be configured to selectively permit refrigerant to flow through to the BCH 414. The first refrigerant cabin loop 464 may include a second compressor 444 configured to provide refrigerant to a condenser 424 and into an accumulator 432. The refrigerant may be supplied from the accumulator 432 to an electronic expansion valve 436 which may selectively route the refrigerant to one or more HVAC heat exchangers such as an evaporator 416 via one or more vales (e.g., thermal expansion valve 438).

Each of the schematics may include one or more temperature sensors 470, one or more pressure and temperature sensors 468, or both. As an example, the first schematic 446 includes a pressure and temperature sensor 468 disposed on each side of the first compressor 408 and a third pressure and temperature sensor 468 may be disposed between the accumulator 432 and the second electronic expansion valve 436. A fourth pressure and temperature sensor 468 may be disposed between the first accumulator 430 and the first electronic expansion valve 434 and a fifth pressure and temperature sensor may be disposed between the second compressor 444 and the condenser 424. A first temperature sensor 470 may be disposed between the first outlet of the valve 400 and the liquid cooled condenser 402, a second temperature sensor 470 may be disposed between the second pump 422 and the inverter and PE 406, and a third temperature sensor 470 may be disposed between the fifth outlet of the valve 400 and the BCH 414.

The second schematic 448 may include the first coolant ESS loop 454, the second coolant ESS loop 456, the first vehicle coolant drive and PE loop 458, the first refrigerant ESS loop 460, and the second refrigerant ESS loop 462, and because those loops are described above with reference to the first schematic, the descriptions of the same will not be repeated. The second schematic 448 may include a first coolant cabin loop 466 that may include the third pump 426 configured to pump coolant to an HVAC PTC heater 428 that may be configured to supply the coolant through a temperature sensor 470 and to a heater core 420. The heater core 420, HVAC PTC heater 428, and the condenser 418 may collectively form a portion of the cabin module 426 (FIG. 25) and air flow (e.g., represented by the directional arrows) may be supplied to the heater core 420.

The third schematic 450 does not include the HVAC evaporator 416 and components fluidly connected to the HVAC evaporator shown in FIG. 31 or the HVAC heater core 420 and components fluidly connected to the HVAC heater core 420.

The fourth schematic 452 includes the first coolant ESS loop 454, the second coolant ESS loop 456, the first coolant vehicle drive and PE loop 458, the first refrigerant ESS loop 460, and the second refrigerant ESS loop 462. The fourth schematic 452 may include a second coolant cabin loop 474 that may be provided with a cabin liquid-cooled condenser 472, the third pump 426, the HVAC PTC heater 428, the heater core 420, and the HVAC evaporator 416.

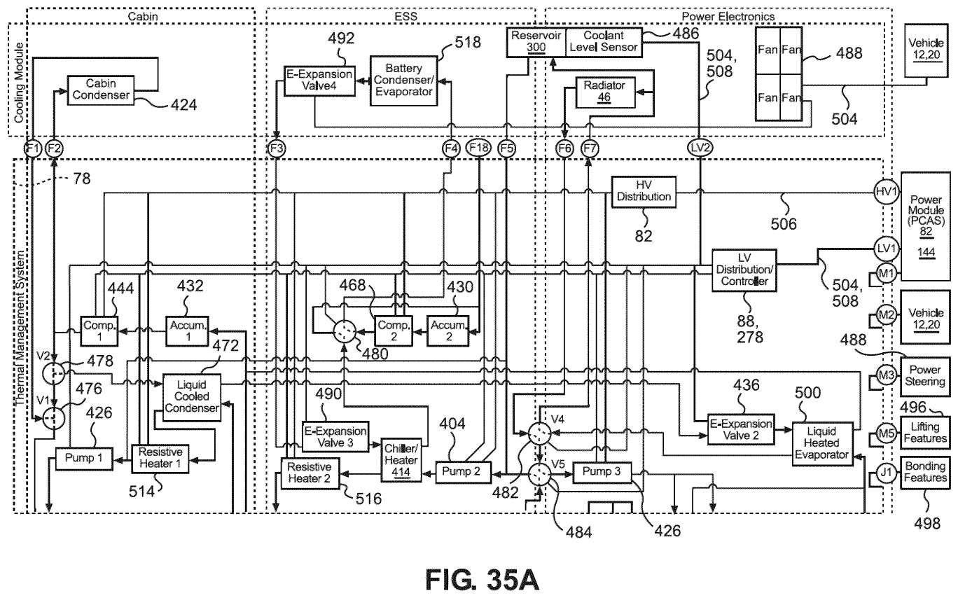

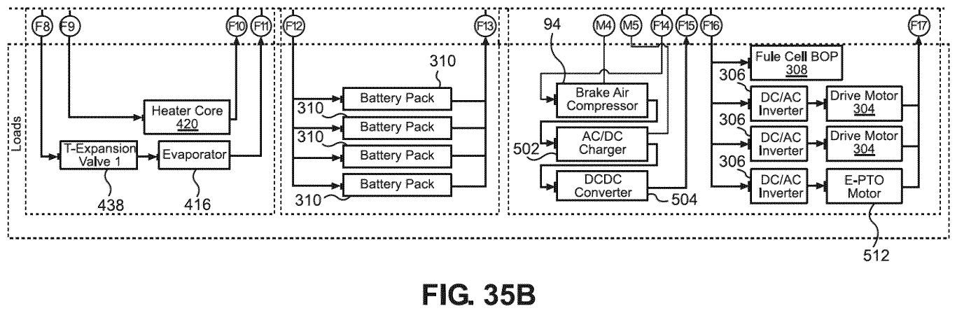

FIGS. 35A and 35B show a schematic fluid and electrical diagram of an exemplary vehicle which includes the TMS 78. As described herein, the PCAS 144 may be configured to support operation of various aspects of a vehicle such as the cabin, the energy storage system (ESS), power electronics, one or more electrical loads, and one or more vehicle accessories or components. The cabin, ESS, power electronics, one or more electrical loads, and the one or more vehicle components may be fluidly, electrically, and/or structurally connected (e.g., mechanically connected) to the PCAS 144. The vehicle components may include a power steering system 488, lifting features 496, and bonding features 498. The distribution assembly 82 of the PCAS 144 may be structurally connected to the vehicle 12, 20 by a mechanical connection such as vehicle mounting frame members M1. The power steering system 488 may be mechanically connected to the vehicle by power steering mounting members M3, and the lifting features 496 (e.g., mechanical or pneumatic suspension components) may be coupled to the vehicle at lifting feature attachment members M6.

A high voltage power input HV1, connected to the distribution assembly 82, may receive HV power from the HVPDU 86 via a HV line 506. Low voltage power and signal inputs LV1, connected to the LVPDU 88 and controller 278, may receive LV power and communications via LV line 504 and communication line 508. The vehicle 12 may be connected to one or more fans such as cooling fans 488 by another LV line 504. The LVPDU 88 and controller 278 may be electrically and communicatively connected to a plurality of components of the TMS 78.

The one or more electric loads may be distributed between the cabin, the ESS, and the power electronics of the vehicle 12 and the TMS 78 is configured to provide refrigerant and/or coolant to enable temperature regulation of the one or more electrical loads. The electrical loads of the cabin may include the temperature expansion valve 438, the evaporator 416, and the heater core 420. The electrical loads of the ESS may include one or more battery packs 310. The electrical loads of the power electronics may include the brake air compressor 94, an AC-DC charger 502, a DC-DC converter 504, the fuel cells 308, the one or more drive motors 304, and an ePTO motor 512.

The TMS 78 may include one or more thermal management units (TMUs) that may be comprised of one or more coolant supply and return lines and one or more refrigerant supply and return lines, and each of the TMUs may be fluidly interconnected by one or more fluid interconnections.

A first TMU may include a cabin condenser supply F2 and a cabin evaporator return F1, a refrigerant cabin evaporator supply F8, a coolant heater core supply F9, a coolant heater core return F10, and a refrigerant cabin evaporator return F11. The first TMU may include the compressor 444 configured to receive refrigerant from the accumulator 432 and provide the refrigerant via the cabin condenser supply F2 to the cabin condenser 424. The cabin condenser 424 may form a portion of the cooling module for the cabin of the vehicle.

The refrigerant cabin evaporator return F1 may route refrigerant from the cabin condenser 424 to a first valve 476. The first valve 476 may be configured to route the refrigerant to the refrigerant cabin evaporator supply F8 and the refrigerant cabin evaporator supply F8 may supply refrigerant to the temperature-expansion valve 438 which may supply the refrigerant to the evaporator 416. The first TMU may include a second valve 478 that may be disposed within the refrigerant cabin condenser supply F2 between the first valve 476 and the cabin condenser 474. The second valve 478 may be configured to selectively route refrigerant to the cabin liquid cooled condenser 472. The coolant heater core supply F9 may receive coolant from the pump 426 and the pump 426 may provide the coolant to the heater core 420. The coolant may be return from the heater core 420, via the coolant heater core return F10 to the liquid cooled condenser 472 and from the liquid cooled condenser 472 to a heater such as a resistive heater 428.

As an example, the LVPDU 88 may be electrically connected to the compressor 444 by the LV line 504, and the compressor 444 and the first resistive heater 514 may receive HV power from the HVPDU via the HV line 506. The controller 278 may be configured to provide commands and receive signals to and from the compressor 444, the pump 426, and the first resistive heater 514 by the communication line 508.

A second TMU may include a refrigerant battery condenser return F3, a refrigerant battery condenser supply F4, a refrigerant charge port F18, a coolant reservoir line F5, a coolant battery supply F12, and coolant battery return F13. The pump 404 may receive coolant from either the coolant reservoir line F5 or a fifth valve 484, or both. The reservoir line F5 is fluidly connected to a reservoir 300. The pump 404 may pump coolant to the BCH 414, and to a second resistive heater 516. The coolant battery supply F12 may supply the coolant from the second resistive heater 516 to one or more battery packs 310 that may be fluidly connected to one another (e.g., in parallel) and the coolant may be returned from the one or more battery packs 310 to the fifth valve 484 via the coolant battery return F13.

The compressor 444 or another compressor 468 may receive refrigerant from an accumulator by way of the refrigerant charge port F18. At least one of the compressors 444, 468 may be configured to supply refrigerant to the third valve 480 may be configured to selectively route the refrigerant to a battery condenser and evaporator 518 via the refrigerant battery condenser supply F4. The refrigerant may be supplied from the battery condenser and evaporator 518 to a fourth electronic expansion valve 492 and the refrigerant battery condenser return F3 may return the refrigerant to a third electronic expansion valve 490 which may be selectively configured to provide the refrigerant to the BCH 414.

The LV line 504 may provide low-voltage power from the LVPDU 88 to the third valve 480, the electronic expansion valve 490, the pump 404, and the fifth valve 484. The controller 278 may communicate 508 with the second resistive heater 516, the pump 404, the electronic expansion valve 490, and the compressor 468 and the HV line 506 may provide HV power from the distribution assembly 82 to the pump 404, compressor 468, and the second resistive heater 516.

A third TMU may include a coolant radiator return F6, a coolant radiator supply F7, a coolant PE supply F14, a coolant PE return F15, a coolant drive supply F16, and a coolant drive return F17. A fourth valve 482 may be fluidly connected to the third TMU and the second TMU (e.g., directly fluidly connected to the fifth valve 484. The third TMU may further include the radiator 46, the second electronic expansion valve 436 and a liquid heated evaporator 500. The expansion valve 436 and evaporator 500 may receive refrigerant from one or more of the compressors 444, 468 disposed in the first and second TMUs, respectively.

The coolant radiator return F6 may provide refrigerant from the radiator 46 to the fourth valve 482 which may be configured to selectively route the refrigerant to the fifth valve 484. The fifth valve 484 may route the refrigerant to the third pump 426 which may pump the coolant to the coolant power electronics supply F14 and the coolant drive supply F16. The power electronics supply F14 may provide the coolant to the brake air compressor 94, the AC-DC charger 502, and the DC-DC converter 504. The coolant drive supply F16 may supply the coolant to the fuel cell 308, DC-AC inverters 306, the drive motors 304, and ePTO motor 512. The coolant power electronics return F15 and the coolant drive return may route the coolant to the liquid heated evaporator 500 and to the fourth valve 482.

The controller 278 may communicate 508 with a coolant level sensor 486 configured to monitor the amount of coolant within the reservoir 300, the second electronic expansion valve 436, the pump 426, the fifth valve 484, and the fourth valve 482. The LVPDU 88 may supply LV power to the coolant level sensor 486, the fourth valve 482, the fifth valve 484, and the second expansion valve 436. The distribution assembly 82 may provide HV power to the third pump 426.

FIGS. 36A and 36B illustrate another fluid schematic diagram 520 according to one or more embodiments. The descriptions and functions of the reference numbers described in the previous figures are equally applicable to FIGS. 36A and 36B and will not be recited again for brevity.

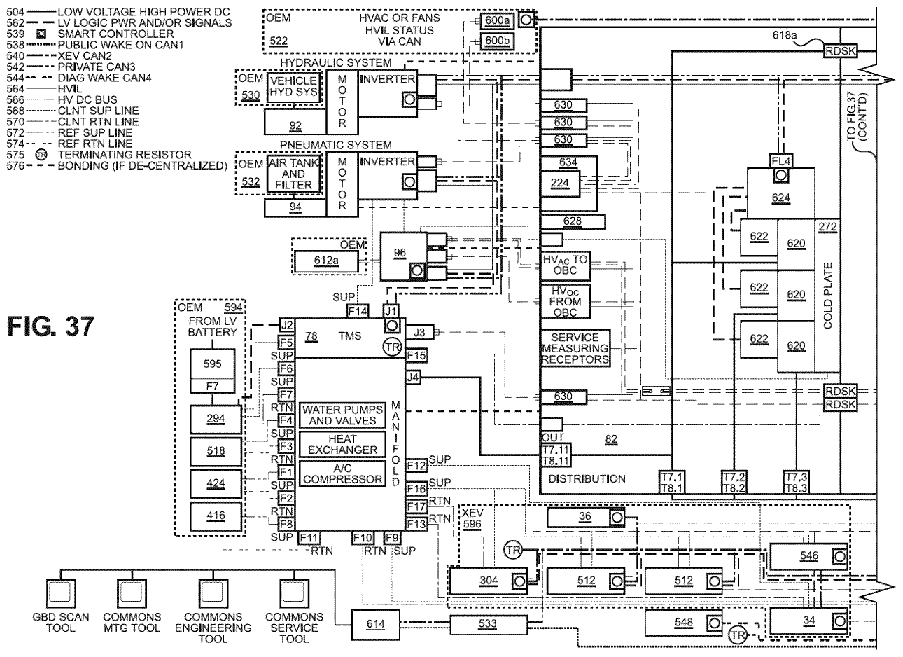

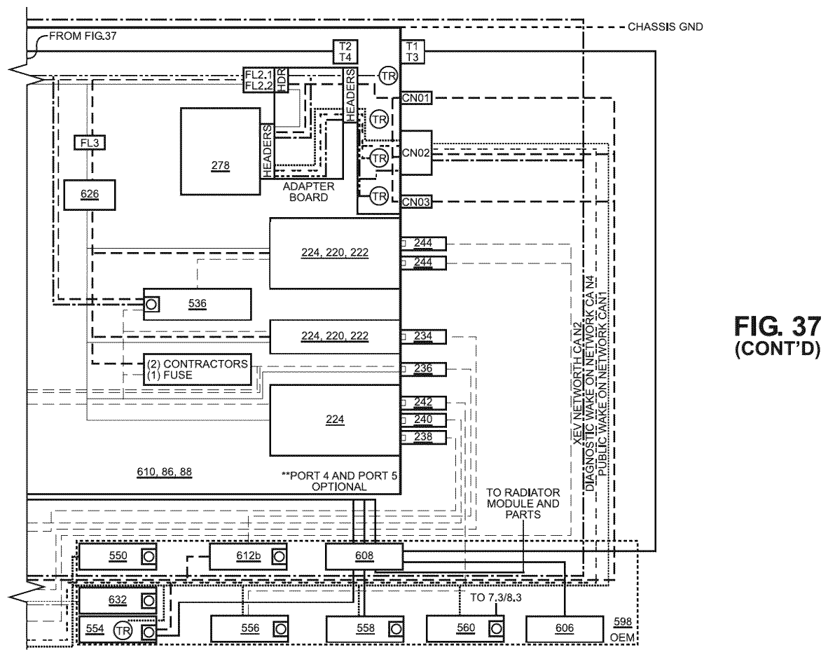

FIG. 37 illustrates a single-line layout diagram of the PCAS electrical system according to one or more embodiments. As described herein, the PCAS 144 may be configured for electrical and fluid connections to one or more vehicle systems (represented by dash-lined boxes) including a hydraulic system 530, pneumatic system 532, and cabin climate control 594, vehicle drive components 596, and power electronics 598.

The PCAS 144 and the one or more vehicle systems may be connected to one another by a low voltage high power direct current line (LVHPDC) 504, a LV logic power and/or signals line 562, smart controllers 539, public wake on CAN1 line 538, XEV CAN2 540, private CAN3, diagnostic wake CAN4 line 544, a HVIL line 564, HV DC bus line 566, coolant supply lines 568, coolant return lines 570, refrigerant supply lines 572, refrigerant return lines 574, a terminating resistor 575 and bonding 576. The diagnostic wake CAN4 line 544 may be configured to trigger a diagnostic protocol in response to a voltage exceeding a predetermined threshold. The HV DC bus lines may be a signal line for exchanging data between one or more controllers.

The PCAS 144 may include the TMS 78, the distribution assembly 82, and a power module 610 that may be comprised of the HVPDU 86 and the LVPDU 88. The PCAS 144 may also include a telematics module 548, a CAN repeater 552, and a service port 614. The service port 614 may be configured to receive one or more scanning, engineering, manufacturing, or service tools.

The vehicle HVAC system 522 may include a smart controller 539 and first and second aux connections 600a, 600b that may be connected to the HV DC bus 566. The hydraulic system 530 may be operatively coupled to the hydraulic pump 92 which may include a motor, and an inverter provided with a smart controller 539. The pneumatic system 532 may include an air tank and filter, coupled to the brake air compressor 94 that include a motor and inverter provided with a smart controller 539. The inverter of the hydraulic pump 92 and the inverter of the pneumatic system 94 may each be connected to CAN3 542, CAN1 538, the HVIL line 564, and HV DC bus 566. The inverter of the brake air compressor 94 may be fluidly connected to the TMS 78 by the coolant supply line 568 (e.g., at F14). The onboard charger 96 may be electrically connected to a combined charging system (CCS1) 612a, the distribution assembly 82 by a HV AC line and a HV DC line extending between HV-AC and HV-AC to OBC and HVA 1200 and HV-DC from OBC. The HV DC bus lines 566 extending between the hydraulic system 530, pneumatic system 532, onboard charger 96 and the TMS 78 may be connected to the distribution assembly 82 by one or more HV safety interlocks 630.

The vehicle power electronics 598 may include a cabin heater 632, a cabin controller 554, a fifth wheel 556, body builder 558, electric steering module 560, a fuse panel 608, a battery (e.g., 12 V battery) 606, and a combined charging system 612b.

The vehicle cabin climate control system 594 may include a fuse panel 595, the cooling module 294, the battery condenser and evaporator 518, cabin condenser 424, and the cabin evaporator 416. The vehicle drive 596 may include one or more drive motors 304, the ePTO motor 512, the fuel cell 308, hydrogen tank 36, a brake resistor 564, and the ESS 34 each of which may be provided with a smart controller. The vehicle power and electronics 598 may include a fifth wheel 556, body builder 558, electric steering control 560, a battery (e.g., 12V battery) 606, a fuse panel 608, and a combined charging system (CCS) 612.

The power module 610 may include a low-voltage direct current (LVDC) module 616 that may be electrically disposed between the LVPDU adapter board 286 and one or more vehicle power electronics 598 components and the distribution assembly 82. As an example, LVHPDC lines 504 may extend from terminals T1, T2 to the fuse panel 608 and from the fuse panel to the distribution assembly 82, the body builder 558, and the cabin climate controller 594. At terminals T2, T4 the LVHPDC line 504 may connect to a radsocket 618a to connect to the distribution assembly 82. The LVHPDC line 504 may extend from the radsocket 618a to DC-DC converters 620. The DC-DC converters may be disposed between gate drive boards 622 and the cold plate or cooling manifold 272 of the distribution assembly 82. The distribution assembly 82 may include a DC-DC low voltage board 524 connected to the gate driver boards 622 by CAN1 lines 538.

The LVDC 616 may be connected to LV logic lines 562 at connections CNO1, CNO2, CNO3 that connect to the LV adapter board 286 one or more components of the vehicle drive system 596. The LVDC may also be connected to the CAN2 lines 540, CAN4 lines 544 for connection with the LV adapter board 286. The CAN4 line may extend from connection CNO2 to the telematics module 548. The CAN2 lines 540 may extend from connection CNO2 to the CAN repeater 552 and service port 614, as well as one or more components of the vehicle drive system 596.

The power module 610 may also include the system control module 278, an isometer and HV measurement module 536, and HV PDU PCBs 626 as well as one or more of the contactors 220, 222, and fuses 224. As an example, the pre-charge circuit 206 may include four contactors 220, 222 and may be connected to ESS ports 244 and lines 564, 538, and 566. The distribution assembly 82 may also include HV interlock PCB 628 and HV fuses PCB 634.

Private CAN3 542 may be communicatively connected to the isometer and HV measurement module 532, the system control module 278, the DC-DC LV board, the hydraulic pump 92, the pneumatic compressor 94, the onboard charger 96, and the TMS 78. The

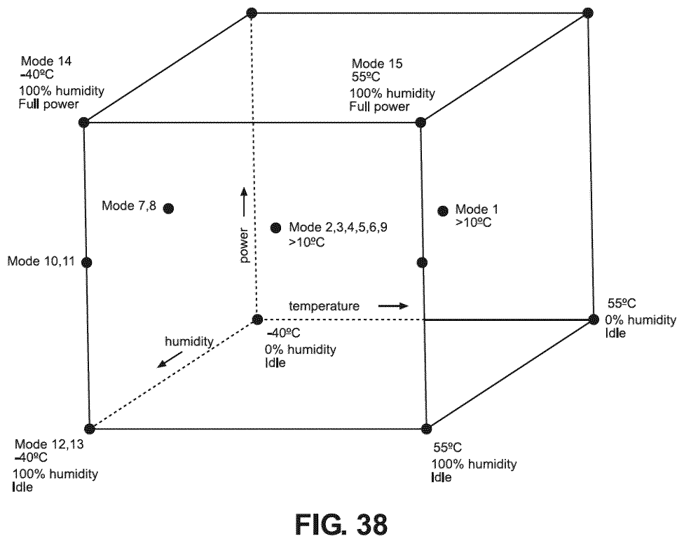

FIG. 38 shows a boundary diagram of the TMS module according to one or more embodiments. The diagram includes three axes, a temperature axis, which may originate at −40° C. and terminate at 55° C., a humidity axis, origination at 0% humidity and terminating at 100% humidity, and a power axis originating at idle and terminating at full power. The humidity and temperature axes correspond to the environment in which the vehicle is located in and the power axis refers to a state of the vehicle's powertrain (e.g., idle or maximum power generated by one or more electric traction motors).

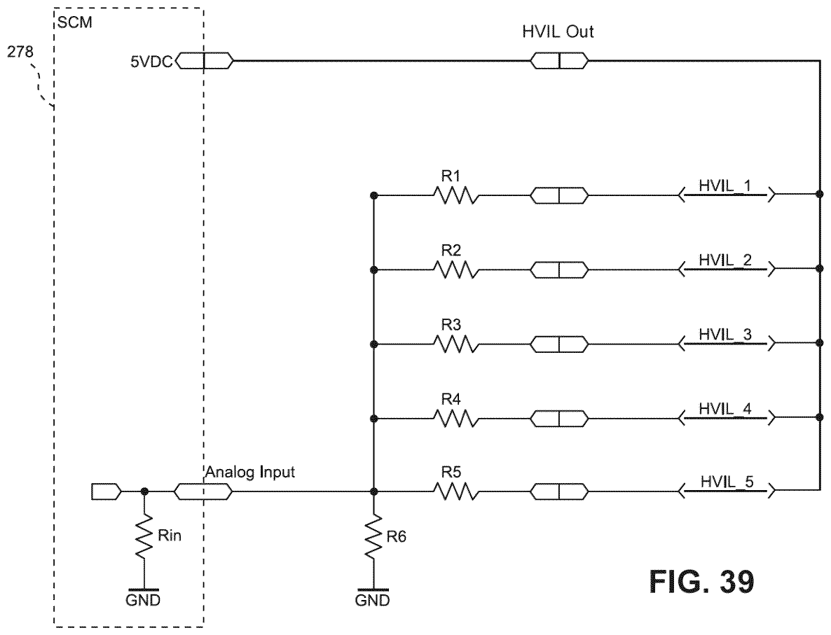

FIG. 39 shows a schematic wiring diagram of one or more portions of ahigh-voltage interlock (HVIL) system according to one or more embodiments. As described herein, the HVIL may be configured to detect one or more conditions such as a broken connection between one or more of the batteries and the HV receptacles or another portion of the HV PDU. In one or more embodiments, the HVIL may be configured to detect one or more broken connections by monitoring an analog input. The analog input may range between 0 and 4,096 bits and depending on which connection is disconnected, the bit count changes which results in a variation in voltage (e.g., between 0 V and 5 V).

The HVIL system may include five HVILs (identified as “HVIL_1” through “HVIL_5” that are connected to an analog input and the controller 278. The amount of voltage Uᵢₙ applied to the Analog Input may depend on the amount of current I conducted through the equivalent resistance of Rᵢₙ and R6, as represented by the equation below:

$${U}_{in} = I / ( \frac{1}{Rin} + \frac{1}{R 6} ) ;$$

Where I depends on the voltage of HVIL Out and the whole resistance R_{eq} where:

$${R}_{eq} = \frac{1}{\frac{1}{Rin} + \frac{1}{R 6}} + \frac{1}{\frac{1}{R 1} + \frac{1}{R 2} + \frac{1}{R 3} + \frac{1}{R 4} + \frac{1}{R 5}} ;$$

Let Rᵢₙ=2.2 kΩ and R6=332Ω, and the equivalent resistance at the Analog Input R_{AI} will be

$${R}_{AI} = \frac{1}{\frac{1}{Rin} + \frac{1}{R 6}} = 288.5 Ω .$$

Let R1=301Ω, R2=365Ω, R3=475Ω, R4=715Ω and R5=1470Ω.

R1, R2, R3, R4 and R5 are connected in parallel, so their equivalent resistance R_{HVIL} will be

$${R}_{HVIL} = \frac{1}{\frac{1}{R 1} + \frac{1}{R 2} + \frac{1}{R 3} + \frac{1}{R 4} + \frac{1}{R 5}} = 97.6 Ω ,$$

and the current

$$I = U / ( {R}_{AI} + {R}_{HVIL} ) = 5 / ( 288.5 + 97.6 ) = 0.01295 A .$$

$$So , {U}_{in} = I \times {R}_{AI} = 0.01295 A \times 288.5 Ω = 3.736 V .$$

As an example, if the HVIL_1 circuit is broken, R1 will be excluded in the circuit and the current will change because of R_{HVIL} will be 144.43Ω, and the Voltage Uᵢₙ will be 3.332 V.

If other HVIL circuits are broken, the voltage Uᵢₙ will also be changed but to another value because of different resistor values R2 . . . R5. The voltage values in different cases are presented in the Table 1:

TABLE 1

| R_{AI} | R₁ | R₂ | R₃ | R₄ | R₅ |
|---|---|---|---|---|---|
| 288.5 | 301 | 365 | 475 | 715 | 1470 |
| 1/R_{AI} | 1/R₁ | 1/R₂ | 1/R₃ | 1/R₄ | 1/R₅ |
| 0.0035 | 0.0033 | 0.0027 | 0.0021 | 0.0014 | 0.0007 |

| V_{HVIL Out} | Case1 | Case2 | Case3 | Case4 | Case5 | Case0 |
|---|---|---|---|---|---|---|
| 5.0 | 3.332 | 3.420 | 3.507 | 3.592 | 3.670 | 3.736 |

It should be understood that the values provided in Table 1 are examples only and may be altered as required. In response to detecting disconnection of one or more HVIL circuits, the controller 270 may command one or more components to warn a vehicle operator or perform mitigation actions (e.g., power off, enter limp mode) as required.

### Modular Design of PCAS

As described herein, the PCAS may be configured for use in FCEVs with different types of chassis including the frame rail, which includes a wide terminal tractor and a standard medium-duty and heavy-duty classes, the low floor frame, and a purpose built chassis. Each of the FCEVs include an electric power take-off module, hydrogen tank, a fuel cell radiator, and a fuel cell DC/DC converter. In the frame rail FCEVs, the PCAS may be disposed on a side of the chassis behind the steps of the vehicle and in front of the ePTO module. In the low floor frame FCEV, the PCAS may be disposed between rails of the chassis and adjacent to the radiator and ESS. In the purpose built chassis, the PCAS may be disposed between the rails of the chassis and between the radiator and fuel cell radiator.

The PCAS may be configured for use in a class 6 or class 7 truck as well as cab over trucks. The PCAS may be connected to one or more electrical and fluid lines that extend to a number of vehicle accessories including those generally identified above. The PCAS may be positioned above portions of the vehicle drivetrain and suspension, such as the front axle and the leaf springs. The PCAS may be disposed behind a heat exchanger. The heat exchanger may be configured to regulate the temperature of one or more vehicle components by transferring heat from coolant traveling from the vehicle components (e.g., the motor transmission unit, batteries, ESS) through the heat exchanger, to air surrounding the vehicle. In one or more embodiments, the heat exchanger may include one or more heat exchangers including but not limited to a radiator, condenser, oil cooler, battery chiller, and a heater core.

The PCAS may be configured for use in a terminal or yard tractor. The terminal or yard tractor includes a cab fixed to a chassis provided with a pair of side rails. As will be described in greater detail below, the PCAS includes one or more fasteners or threaded holes to enable sides of the PCAS to be fixed to one or more portions of the chassis, such as the side rails.

The PCAS may be configured for use in vehicle provided with a skateboard chassis. The skateboard chassis may be configured for use in several heavy and medium duty vehicles including but not limited to long-haul trucks. The skateboard chassis includes a base structure or a platform, which houses the batteries, electric motors and other electronic components. As one example, the PCAS may be positioned at a front end of the platform and disposed above the front axle. The PCAS may be disposed behind and fluidly coupled to one or more heat exchangers by one or more fluid lines.

The PCAS may be specifically configured for construction or mining vehicles. The PCAS may include four blades, such as the core module, the DC/DC converter, the onboard charger, and the distribution blade. The PCAS includes a low voltage battery pack and a low power ePTO combined with the TMS. The low voltage battery pack may be fixed to one or more attachment apertures formed by bottom surfaces of one or more of the blades and the low power ePTO and TMS may be fixed to the low voltage battery pack. Alternatively, the low voltage battery pack and the low power ePTO and TMS fixed to at least one side of the distribution blade.

In one or more embodiments, the PCAS includes one or more blades or segments that are fixed (e.g., bolted or fastened) to one another. Each blade may provide one or more functions for the operation of the PCAS. As an example, a core module is provided with a controller or supervisory control module, a low-voltage distribution panel (LVD), and a high-voltage distribution panel (HVD) provided with an electrical interface for the vehicle and high-voltage connectors and an input connector port. The input connector port may be configured for charging inlets that provide level 2 AC charging capability.

The core module may be fixed to a DC-to-DC converter (identified by “DC/DC”) converter which may include one or more electronic circuits, an electromechanical device, or both that converts a source of direct current from one voltage level to another. An onboard charger is electrically connected to the DC/DC and regulates the flow of energy into the vehicle battery packs as they are recharged while accounting for rising internal resistance of the batteries as their state of charge increases. The onboard charger eliminates the need for external battery chargers and may save tens of thousands of dollars per vehicle in infrastructure costs and simplify the recharging process. A distribution module or distribution blade (identified by “Distribution Blade”) is fixed to the onboard charger and is configured to deliver power to one or more electric loads within the PCAS 10 and the vehicle while protecting electrical and electric components by use of electric switches in place of traditional fuses.

The PCAS includes a thermal management system (TMS) that may be fixed to one or more of the distribution blade, the onboard charger, DC/DC, and core module. As will be described in greater detail below, the TMS may facilitate regulating the temperature of one or more vehicle components.

The core module, DC/DC converter, onboard charger, and distribution blade may be formed as separate components (referred to herein as blades) and attached to one another by a number of fasteners that extend through ears or flanges extending from a main body of each separate blade. It should be understood however, that these separate blades (i.e., the core module, DC/DC converter, onboard charger, and distribution blade) may be combined into a single housing or more than one structural housings, as will be described in greater detail below. The TMS may include a TMS housing that may be attached to one or more sides of the blades. The TMS housing and one or more of the blades may include a number of vehicle attachment apertures (e.g., threaded openings) that receive fasteners (e.g., bolts) to enable attachment of the PCAS to a chassis or other structural member of the vehicle.

The PCAS may be provided with a removable TMS attachment plate that may be fixed or connected (e.g., directly connected) to the TMS housing to a core module of the PCAS. The removable TMS attachment plate may enable easier serviceability of components disposed near the TMS housing. The TMS attachment plate may include attachment members (e.g., flanges, protrusions) that may extend from an outer periphery of the plate. The attachment members may be configured for attachment to attachment flanges disposed on or integrally formed with the core module.

PCAS may include a low-voltage distribution module (LVD) provided with connectors and circuitry fixed to a mounting plate. The mounting plate and arranged orthogonal to a front face of the core module.

The PCAS may include a core module configured to carry a TMS housing, the power steering pump, and brake compressor. The side of the core module disposed closest to the power steering pump and brake compressor may include an LVD module and HVD module. T-shaped positive and negative busbars, may be disposed in the core module and electrically connect the LVD and HVD to a DC/DC converter.

The PCAS may include a core module provided with a housing and a top cover that closes off an opening of the housing. A first side surface of the housing may be configured to receive a HVD module and an opening in the top cover may be configured to receive the LVD module. The core module housing includes a HVPDU and a DC/DC converter, the HV PDU may be spaced apart from the DC/DC converter by a divider plate.

As described herein, the PCAS may be fluidly coupled to one or more vehicle systems which enable routing and distribution of fluid (e.g., coolant) and heat transfer of the same to regulate the temperature of one or more vehicle accessories. The TMS housing and the core module (or one or more of the blades) may include a number of inlet connectors and a number of outlet connectors each configured to receive and expel fluid. The inlet and outlet connectors, are fluidly connected to one or more passageways or conduits formed by or disposed within one or more of the blades and the TMS housing.

As described herein, the PCAS provides a modular design allowing original equipment manufacturers (OEMs) to choose from several variants which may vary in content. As shown, the PCAS includes three blades, incorporating the core module and DC/DC converter into one housing. As an example, the PCAS may include a brake air compressor and a power steering pump. The inclusion or exclusion of the brake air compressor and the power steering pump allows the OEM to pick and choose the content of the PCAS, so that the OEM may incorporate their own or another's accessory as required, without altering the blades or TMS housing. To further enable this “plug-and-play” modularity, one or more of the blades may include a high-voltage receptacle as well as inlet and outlet connectors, that may be connected to a power steering pump, brake air compressor, or another vehicle accessory provided by the OEM or another party.

The PCAS may be specifically configured for construction or mining vehicles. The PCAS may include four blades, include the core module, the DC/DC converter, the onboard charger, and the distribution blade. The PCAS includes a low voltage battery pack and a low power ePTO combined with the TMS. The low voltage battery pack may be fixed to one or more attachment apertures formed by bottom surfaces of one or more of the blades and the low power ePTO and TMS fixed to the low voltage battery pack. Alternatively, the low voltage battery pack and the low power ePTO and TMS fixed to at least one side of the distribution blade.

In one or more embodiments, the PCAS may include a single core module housing that contains the core module and the distribution fixed directly to the TMS (e.g., directly) by an adapter plate disposed between the distribution assembly and the TMS. The core module housing includes a cover that may be attached to the core module housing by one or more fasteners or other suitable means as required. One or more exterior surfaces of the core module housing may include notches or channels to enable removal of the cover. As an example, after the fasteners are removed to enable removal of the cover, one may insert a tool or finger within the grooves so that a rear surface of the cover is accessible and the cover may be pushed or pulled away from the core module housing. Additionally or alternatively, one or more exterior surfaces of the core module housing may include the attachment apertures and the attachment apertures may be covered by a plug or fastener when the attachment apertures are not in use.

The cover includes a low-voltage distribution module (LVD) and a high-voltage distribution module (HVD). As described herein, the LVPDU 88 and the HVD are separate components to enable independent serviceability of the LVD and the HVD. The LVD may include an access cover which may be removed to access the interior of the core module.

The stepped structure of the HVPDU receptacles may be removable from the high-voltage panel and one or more gaskets may be fixed to one of the HVD and the stepped structure to provide a water-tight or water proof seal between the stepped structure and the HVD. Additionally or alternatively, one or more gaskets, may be disposed between the cover and the low-voltage panel and the high-voltage panel and a seal or gasket may be disposed between the core module housing and the cover. Each of the gaskets or seals and corresponding mating components may collectively provide ingress protection against dust or water (e.g., IP6K9K compliant).

A controller may be disposed behind the LVD and a rear surface of the cover. As will be described in greater detail below, the controller may be operatively connected to and configured to control the PCAS by one or more input and output connectors. As an example, one or more posts or dowels (e.g., four) may extend from the rear surface of the cover and carry the controller so that the controller is spaced apart from the cover to accommodate a rear portion of the LVD that is disposed behind the cover. The controller may be suspended above a shield that may extend in a horizontal direction from the rear surface of the cover. One or more portions of the housing, the cover, and the shield may be formed of cast aluminum or another suitable alloy, as required. The shield may be configured to protect or shield the controller and one for more controller area networks (CAN) from electromagnetic interference (EMI).

The core module housing may be configured to house or receive the DC/DC converter, a cooling channel cover, and a high-voltage power distribution unit cooling manifold. The cooling channel cover may cover or cooperate with portions of the housing to enclose a cooling channel (not illustrated here) for the brake air compressor.

The DC/DC converter may be configured to convert high voltage from one or more batteries or strings of batteries to a lower voltage (e.g., 12V or 24V) to enable powering of one or more components such as cabin accessories. The DC/DC converter may be fluidly connected to the TMS and may include one or more coolant channels or passages in which coolant may be routed to capture or provide heat to and from the DC/DC converter. As shown, the coolant passages are closed off by a cover fixed to a front face of the DC/DC converter. A connector may be positioned at an upper region of the DC/DC converter and as will be described in greater detail below, the DC/DC converter connector may be electrically connected to one or more receptacles (e.g., a low-voltage receptacle).

The power steering pump includes an inverter and the electric brake compressor includes an inverter, and each of the inverters changes direct current to alternating current. The TMS may be electrically connected to the core module so that that the core module is enabled to provide power to the TMS and so that the controller of the core module is enabled to provide commands to and control operations of the TMS. As an example, a high-current-low-voltage power supply is provided to supply power to the TMS and a high-voltage power supply is provided to supply power to the steering pump and brake air compressor. Logic power, wake signal, CAN communication, and a high-voltage interlock (HVIL) to one or more controllers of the TMS (not illustrated) by way of connector.

As described herein, the PCAS is designed for ease of manufacturing and serviceability. As an example, the power steering pump and brake compressor may be fixed to a platform that is adjustable with respect to fixed to rails. The rails may be fixed or directly connected to a top surface of the TMS housing. As another example, the power steering pump may include an air filter that is disposed in a position that is accessible and readily serviceable. A vertical wall disposed adjacent to the recessed surface 96 may include an inlet or outlet connector from which a fluid line or hose may extend to fluidly connect the TMS housing to the core module housing. The recessed surface may enable positioning of the fluid line or hose to ease installation of the hose while minimizing bending and possible kinks within the line.

The HVPDU includes HV busbars that may be disposed in either a negative plane or a positive plane and which enable distribution of HV power from the HV DU. End portions of the HV busbars may be electrically connected to the contactors. One or more HV round body fast acting fuses may be provided to protect the ESS, DC fast charging system, drive inverter, and high voltage bi-direction power ports. The HV PDU may include one or more sensors such as current and high voltage sensors that may be operatively connected to one or more controllers (e.g., controller) to enable control of logic power and CAN communications that may monitor current and voltages of portions of the HVPDU (e.g., the HV busbars).

A rear surface (or another portion) of the core module housing may include a number of interfaces for one or more vehicle accessories. As an example, receptacle and receptacle may be disposed adjacent to a fluid inlet connector that may be fluidly coupled to an outlet 46 disposed on a side of the core module housing. The receptacles, may provide HV power from the core module housing to one or more components of the TMS (e.g., a PTC heater and AC compressor).

In one or more embodiments, the core module or the distribution assembly may include one or more receptacles. The receptacles may be configured to receive the connector to enable supply of low voltage logic power, drive power wake, CAN communication and HVIL circuit for the TMS and pneumatic and hydraulic accessories such as power steering pump and brake air compressor. Poke yoke keyed connectors, may be provided to supply LV power to the vehicle cabin while preventing reverse polarity to protect LV components within or on the vehicle.

The core module may include one or more cooling conduits or passages to regulate the temperature of the components disposed within the core module housing. As an example, the HV PDU cooling manifold may be integrally formed with or assembled to a portion (e.g., an inner portion of the core module. The cooling manifold may be positioned adjacent to the HVPDU. The cooling manifold may include one or more coolant passages or in which coolant flows through to transfer heat to and from the HVPDU.

One or more busbars may be fixed to one or more inner walls or surfaces of the core module. As an example, first and second busbars, may be positioned adjacent to and connected to the HV PDU by one or more connectors. An end portion of the busbars disposed opposite of the ends adjacent to the HV PDU may extend to the receptacles. One or more wires may be connected to the first and second busbars and to the receptacles. A third busbar may include one end configured for electrical connection to the DC/DC converter (FIG. 19) and another end may be connected to the receptacles.

The LVPDU may include an electrical interface to enable connection to the controller and an electrical interface to the PCAS. The interface may include a first header and a second header provided with thirty-six rows and two pins for each row. The interface to the PCAS may include Pogo pins provided with twenty-two rows and two pins per row and a Radsok pin and socket.

In one or more embodiments, the core module includes the LVD module or panel and HV PDU. A rear surface of the core module includes locating pins configured to position the core module with respect to another blade such as the DC/DC converter. The LVD and HV PDU may each include spring-loaded pins configured to electrically disconnect the LVD and HV PDU as the core module is removed from the DC/DC converter.

The HV PDU includes a removable cover which receives the HV connectors. Contactors may be fixed to the removable cover so that the contactors are electrically connected to the HV connectors. The pre-charge resistor, pre-charge circuit (including the contactor for the pre-charge circuit), and a ground fault detector are then fixed to the removable cover. As depicted in FIG. 43 and FIG. 44, one or more negative busbars and one or more positive busbars may be connected to the contactors. One or more fuses such as the fast acting fuses may then be connected to the busbars, and contactors.

The PCAS may include one or modules, including a core module, DC/DC converter, onboard charger, a distribution plate, an inverter, and thermal management system, each of which includes a number of components (identified by the shaded boxes) The PCAS may be operatively connected to one or more vehicle components including a steering system (e.g., the steering gear), brake air tank and filter, which is connected to the brake air compressor, a traction drive, the energy storage system, a cabin evaporator, a cabin condenser, an AC charger, a charge plug, traction drive, ePTO, the cabin, LV battery and fuse disconnect, and body builder. Each of these vehicle components may be connected a LV high power bus, a LV low power & communications bus, a LV control line, HV DC line bus, HV AC load bus, HV AC bus, and a coolant and/or refrigerant line.

As described herein, the LVPDU may be configured for built in redundancy to ensure power supply in cases of a shorted cable. The LVPDU a cabin module, and body builder may form a circuit including two cables extending between two negative terminals of a 12 V battery to two terminals. The two cables may be connected to a negative busbar. Two positive cables are connected to the 12 V battery through a main switch and are connected to two fuses before terminating at a positive busbar. Two resistors may be provided to monitor the health of the battery connection, each of the resistors are connected to a positive terminal, before the fuse, and an individual analog input. If both positive battery cables are in acceptable health, each analog input senses a common voltage. However, if one of the cables is shorted (e.g., by contacting the chassis) two fuses connected to the cable will open the circuit, while the other two fuses of non-shorted cable will maintain a closed circuit, so that a power supply of at least 12 V is provided to the vehicle. Under those circumstances, the analog inputs will detect different voltages (0 V for the shorted cable and 12 V for the non-shorted cable) and, in response to the voltage variation, the controller may provide a warning to operator or command another action (e.g., engage) limp mode.

### TMS Alternative Aspects

The present disclosure contemplates use of the PCAS and/or the TMS with various vehicle systems including BEVs and other configurations (e.g., a thermal management system for FCEV) are readily applicable to this disclosure. One or more coolant lines may fluidly connect the TMS module to one or more vehicle components, including but not limited to a cooling module, motor and inverter, one or more battery packs, and a cabin module. The cooling module may be fluidly and electrically connected to a reservoir to receive or provide excess coolant, as required. The cabin module may also be connected to the TMS module by a refrigerant line, in which refrigerated coolant may be routed from the TMS (e.g., by way of a compressor) to the cabin module and the cabin module may include one or more heat exchangers and fans collectively configured to cooperate with one another to regulate the temperature of the vehicle cabin. A control panel may be electrically connected to the cabin module to control the operation of the cabin module.

The TMS may include a nine-way valve provided with nine valves (identified numerically as 1 through 9 and referred herein as first valve through ninth valve), one or more of which may be closed or open as required. The valve may be fluidly connected to one or more fluid circuits including a first circuit, a second circuit, a third circuit, a fourth circuit, and a fifth circuit. While each of the circuits include one or more components, it should be understood that one or more of the circuits may include fewer components, more components, or different components than those described below. What is more, some of the circuits may be eliminated entirely. As an example, the third circuit may only be employed when ambient temperatures are predicted to equal or exceed 45° C.

As described herein, the TMS module may provide a maximum cooling capacity of 24 kW (at an ambient temperature of 38° C.) and a maximum heating capacity of 13 kW (at an ambient temperature of −5° C.). The maximum cooling capacity may be divided between a cabin cooling capacity (ranging between 6 kW and 10 kW) and a battery cooling capacity (ranging between 14 kW and 18 kW). The maximum heating capacity may be divided between a cabin cooling capacity (ranging between 11 kW and 15 kW) and a battery cooling capacity (ranging between 10 kW and 14 kW). The inverter of one or more of the PCAS described above may have a cooling capacity ranging between 17 kW and 25 kW with a coolant flow rate of 105 liters per minute at a pressure of 55 kPa.

Additionally or alternatively, the TMS module may provide a maximum cooling capacity of 36 kW (at an ambient temperature of 55° C.) and a maximum heating capacity of 38 kW (at an ambient temperature of −40° C.). The maximum cooling capacity may be divided between a cabin cooling capacity (ranging between 7 kW and 16 kW) and a battery cooling capacity ranging between 12 kW and 20 kW). The maximum heating capacity may be divided between a cabin heating capacity (ranging between 10 kW and 22 kW) and a battery heating capacity (ranging between 12 kW and 16 kW). The inverter of the PCAS may have a cooling capacity ranging between 13 kW and 44 kW with a coolant flow rate of 60 liters per minute at a pressure drop of 150-200 kPa.

The first circuit may include a third pump which may supply coolant to the third valve, which may route fluid to the first valve. The first valve may provide coolant to the battery and from the battery to the second valve. The second valve may direct coolant to the fourth valve, which may provide coolant to the inverter and the inverter may return the coolant to the third pump.

One or more temperature sensors may be disposed within each of the circuits and may be configured to measure the temperature of the coolant passing as the coolant flows through the temperature sensors. The temperature sensors may be operatively connected to one or more controllers (e.g., the controller, the vehicle CAN BUS, or a controller dedicated to the TMS) and the one or more controllers may be configured to alter the operation of the TMS based on the measured temperatures (among other factors). A second temperature sensor T2 may be disposed between the battery and the second valve, and a third temperature sensor T3 may be disposed between the third pump and the third valve.

One or more circuits of the TMS include a number of condensers designed to transfer heat from a working fluid (e.g., coolant or refrigerant) to a secondary fluid or the surrounding air. In one or more embodiments, the TMS includes a first liquid cooled condenser and a second liquid cooled condenser. It should be understood that other types of condensers (e.g., those not liquid cooled) are readily contemplated by this disclosure.

The second circuit may include a second pump which may be configured to route pressurized coolant to the eighth valve which may provide coolant to the fifth valve. The fifth valve may direct coolant through a radiator where the coolant captures heat from the forced towards the radiator by a fan disposed adjacent to the radiator. The heated coolant flows from the radiator to the LCC2 where it is condensed and routed out of the LCC2 to the seventh valve which may route the coolant to the ninth valve. The ninth valve may route the coolant to a chiller (identified as “chiller”) and the chiller may cool the coolant. The chiller may direct coolant to a positive temperature coefficient heat exchanger (referred to herein as “WPTC2”) and the WPTC2 may direct the coolant to the second pump. The second pump may direct coolant through the eighth valve and to the fifth valve, where the coolant is then routed to return to the radiator.

Under certain circumstances, the nine way valve may be actuated or altered to close off one of the nine vales and open the sixth valve which may direct coolant from the nine way valve to the coolant line or passage disposed between the radiator and the LCC2. The second circuit may include one or more temperature sensors such as a fourth temperature sensor T4, disposed between the LCC2 and the seventh valve, a fifth temperature sensor T5, disposed between the fifth valve and the radiator, and a sixth temperature sensor T6 that may be disposed between the ninth valve and the chiller.

The fourth circuit may include a compressor which may compress the coolant and route the coolant to the LCC1. After the coolant is routed through LCC1, the coolant may be directed towards the LCC2. A first expansion valve, and under certain circumstances, the first expansion valve may be opened to permit the coolant into the LCC2. The LCC2 may direct the coolant towards a second expansion valve (identified as “EXV2”) and a third expansion valve (“LEXV”). If the EXV2 is opened, coolant is routed to a cabin evaporator (identified as “Cabin evaporator”) to an accumulator (identified as “ACCU1”). If the LEXV is opened, the coolant is routed to the chiller and then to the accumulator.

The third circuit may include a condenser (identified as “Condenser”) that may be disposed adjacent to the radiator. The third circuit may receive coolant from the fourth circuit and the coolant may be routed to a shut-off valve (identified as “R-SOV”) and if the R-SOV is open, the coolant may be routed to the condenser. After the coolant is condensed by the condenser, the coolant may be returned to the fourth circuit.

The fifth circuit may include a first pump (identified as “Pump1”) which pumps coolant through LCC1 to a positive temperature coefficient heat exchanger (identified as and referred to herein as “WPTC1”). The WPTC1 may route coolant to a heater core (identified as “Heater core”) in which heated coolant passes through tubes or fins of the heater core so that a cabin blower (identified as “Cabin blower”) may operate to force heated air into a cabin of the vehicle to heat the cabin.

It should be understood that aspects of the vehicle's thermal system may be supplemental to the fluid routing diagram described above. The vehicle's thermal system may be divided among three portions such as a cabin portion, the TMS module portion, and a vehicle drive and accessory portion. The cabin portion is shown on the left side of FIG. 35A and is bounded by a rectangular box formed by dotted lines. The ESS portion is shown in the middle of FIG. 35A and the power electronics portion bounded by another rectangular box formed by dotted lines on the right side of FIG. 35A.

The nine-way valve and components that may be fluidly connected to the nine-way valve may operate in one or more positions. In a first position or operating state, in which the chiller, the battery, the power electronics, and radiator are in isolated fluid circuits. In a second position or operating state, the coolant is routed from the chiller to the battery and from the battery to the power electronics. The coolant may then be routed to a condenser, such as a liquid cooled condenser (identified as “LCC”) and a valve operatively connected to the LCC. After the coolant is routed through the LCC, the coolant may be directed to return to the chiller. As an example, when the nine-way valve is in the second position, the radiator may be excluded so that coolant does not travel through the radiator.

In a third operating state, in which the components, including but not limited to the chiller pump, chiller, the LCC, the radiator, power electronics pump, power electronics, and the battery. It should be understood that the term “power electronics” may refer to one or more of the electronics of one or more embodiments of the PCAS described herein. This includes but is not limited to the DC/DC converter (such as the DC coolant passages), the HV PDU cooling manifold, and the cooling passages for the brake air compressor. The coolant may be routed from the chiller pump to the chiller, and from the LCC. After the coolant flows through the LCC, the coolant may be routed to the radiator and from the radiator to the power electronics pump. The power electronics pump may pump the coolant to the power electronics, and then to the battery.

In a fourth position or operating state, in which the power electronics and the battery are each in isolated circuits and the chiller, LCC, and the radiator are in an isolated circuit. The nine-way valve disposed in the fourth operating state may provide coolant to the power electronics pump, through the power electronics and to the battery. FIG. 24E shows a schematic diagram of the nine-way valve and a chart that identifies each of the valves (numbered one through nine) and associated components that may receive coolant from each of the nine valves.

The TMS includes a TMS housing provided with a number of fluid inlets and outlet connectors disposed on one or more sides of the housing. The housing may include a stepped portion including a recessed top surface disposed between the electric power steering pump and electric brake compressor. A TMS controller housing is provided to house one or more controllers (not illustrated) of the TMS. The controller housing may be integrally formed with or attached to the recessed surface and may include one or more electric or communication receptacles to supply power and enable communication to the TMS controller.

### Alternative Aspects of the PCAS Power Module

The High-Voltage/Low-Voltage Core module may include a variety of modules or subsystems. There may be a low-voltage (LV) module that may include a control board. The control board may include a controller, processor, programmable logic array, microprocessor, etc. The control board may include a variety of connections. The control board may also include a low-voltage direct current fuse and relay portion that is made of one or more terminals and connectors. In one embodiment, three connectors may be utilized for the low-voltage subsystem, but any number of connectors may be used. The connectors may be utilized to connect a plug/connector (or any type of connector) of a vehicle to pass a charge from the module to the vehicle. In another embodiment, the LV subsystem may include a terminal block with four terminals. The terminals may be utilized to connect any number of wires together. The control board may also include an adapter board.

The controller may be configured with thirty-seven analog inputs, twenty of which may be configurable for pull up and pull down, five of which enable system wake up and inputs, six of which may be frequency inputs, and fifteen of which may enable power supply monitoring and feedback. The controller may be configured with thirty-two low side driver outputs, ten high side driver outputs, four H-bridge drivers, and one main power relay driver. In one or more embodiments, the controller may have an operating range between 9 V and 32 V. The controller is configured to communicate via four CAN channels, one LIN master, and one Ethernet connection. The controller may be configured to operate at a range of temperatures e.g., −40° C. to 110° C. and may be enabled to meet a rank of Protection structure (e.g., IP6K9K) which is regulated by DIN standard DIN40050 Part9.

In one or more embodiments, the controller includes an integrated or inbuilt charge controller and gradient sensor. The gradient sensor may be configured to measure slope, acceleration, and temperature. As described herein, the controller may include an inbuilt or integrated charge communication chip to enable AC and DC fast charging and elimination of an external charge controller.

As described above, the PCAS may include a pre-charge module which may limit inrush current prior to or as the vehicle is turned on. A connector such as an ePTO connector may be provided to supply up to 200 kW for electric power take-off operations and another connector may be provided to enable DC fast charging of up to 300 kW. The DC-DC converter may be configured to convert up to 20 kW. The on-board charger may be configured to provide 11 kW, 22 kW, or another quantity of electric power, as required.

In one or more embodiments, electrical connections of the HVPDU may be formed between the high-voltage connectors, the pre-charge resistor, the pre-charge circuit, the contactors, and fast acting fuses.

The PCAS may operate in various modes as commanded or monitored by a controller. One method may begin by connecting a battery (e.g., the 12 V battery) to the controller. A system basis chip (SBC) enters initiation or initial mode so that SS1 and SS2 is low, and CAN, sensor, MCU power is available, as represented by operation. The controller may then start up and the SBC may enter normal mode in which SS1 and SS2 are high. One or more batteries may be enabled so that peripheral chips are ready to perform one or more operations as represented by operation. In operation, the controller determines whether the initial function of application software is operating according a set of predefined criteria, if the criteria is not met, the controller will not wake and branches to operation, in which a state of charge (SOC) and health check of the 12 V and HV batteries.

If the criteria of operation is met, the controller branches to operation to execute ASW. After operation, the vehicle may be moving or at a certain speed as represented by operation. If SOC and the health check in operation is acceptable, the controller may branch to another operation and if not acceptable the controller may branch to an operation in which the controller stops and enters sleep mode. The SBC may enter sleep mode for a predetermined amount of time (e.g., four hours). After sleep mode, the timer may expire or controller may enter wake mode and terminates. The controller may branch to an operation in which the vehicle is at a stand-still or in park, and upon detecting a key-off event, the controller branches to an operation in which non-volatile memory (NVM) data is written. After the NVM is written and upon detecting a key-off event, the controller may branch to an operation in which the vehicle enters limp home mode.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

1. A power control and accessory system module configured for use in a vehicle, the module comprising:
a thermal management system (TMS) configured to receive and supply one or more fluids to regulate a temperature of one or more vehicle accessories, the TMS including a TMS housing formed by one or more sidewalls and a top wall extending between the one or more sidewalls;
a distribution assembly including a base and one or more peripheral walls extending from the base and defining an opening, the base and the one or more peripheral walls forming a receptacle accessible via the opening, wherein at least a portion of the base of the distribution assembly is fixed to and lies along a first sidewall of the one or more sidewalls of the TMS housing; and
a core assembly, wherein the distribution assembly is disposed between the core assembly and the TMS housing, wherein a converter is disposed within at least one of the core assembly and the distribution assembly, and the converter is configured to receive electric power at a first voltage from a power source and distribute the electric power at a second voltage to from distribution assembly to the one or more vehicle accessories.

2. The module of claim 1, wherein the one or more peripheral walls of the distribution assembly are directly connected to the core assembly.

3. The module of claim 2, wherein the one or more vehicle accessories includes an on-board charger fixed to the top wall of the TMS housing, and wherein another vehicle accessory of the one or more vehicle accessories and the top wall of the TMS housing sandwiches the on-board charger.

4. The module of claim 2, further comprising:
a high-voltage power distribution unit (HVPDU) configured to supply high-voltage power to some of the one or more vehicle accessories, wherein the core assembly includes a front portion and a rear portion, the front portion fixed to the one or more peripheral walls of the distribution assembly, and the rear portion defining an opening configured to receive a portion of the HVPDU.

5. The module of claim 1, further comprising:
a low-voltage power distribution unit (LVPDU) configured to supply low-voltage power to some of the one or more vehicle accessories, wherein the core assembly is disposed rearward of the distribution assembly and the LVPDU is disposed forward of the distribution assembly.

6. The module of claim 5, wherein the one or more peripheral walls of the distribution assembly are directly connected to the core assembly.

7. The module of claim 5, wherein the LVPDU is disposed above the TMS housing.

8. (canceled)

9. (canceled)

10. The module of claim 1, wherein the distribution assembly includes one or more electrical switches configured to cease distribution of the electrical power to the one or more accessories in response to an overflow of current within one or more electrical circuits electrically connected to the one or more accessories of the module.

11. A power control and accessory system (PCAS) configured for use in a vehicle, the vehicle including a vehicle chassis, the vehicle chassis provided with a front end, a rear end, a longitudinal vehicle axis extending there between, an energy storage system, and a cabin module the cabin module configured to provide conditioned air to a cabin of the vehicle, the PCAS comprising:
a distribution assembly including a distribution housing configured to house one or more electrical circuits, wherein a first electrical circuit of the one or more electrical circuits is configured to receive electric power from the energy storage system and distribute the electric power to one or more vehicle accessories;
a thermal management system (TMS) directly connected to the distribution housing and configured to route refrigerant to the cabin module and route coolant to a coolant structure disposed in or defined by the distribution housing, wherein the TMS includes a TMS housing, wherein the TMS housing is disposed closer to the front end of the vehicle chassis than the distribution assembly;
a core assembly provided with a front portion and a rear portion, the front portion fixed to one or more peripheral walls of the distribution assembly and the rear portion defining an opening, wherein the distribution assembly is disposed between the core assembly and the TMS; and
a high-voltage power distribution unit (HVPDU) configured to supply high-voltage power to some of the one or more vehicle accessories, wherein the opening defined by the rear portion of the core assembly is configured to receive at least a portion of the HVPDU.

12. The module of claim 11, wherein the one or more vehicle accessories includes an air compressor configured to provide pressurized fluid to at least one friction brake of the vehicle.

13. The module of claim 11, wherein the one or more vehicle accessories includes a steering pump configured to receive provide pressurized fluid to a steering assembly of the vehicle.

14. The module of claim 11, wherein the distribution assembly is fluidly connected to the TMS.

15. The module of claim 11,
wherein the distribution housing includes a base and one or more peripheral walls, the base and the one or more peripheral walls defining a receptacle, wherein at least one of the core assembly and the distribution assembly includes a cover, the cover configured to cover the receptacle,
wherein the TMS is provided with one or more rear fluid connections, the TMS housing including a rear wall and the one or more rear fluid connections extending from the rear wall of the TMS housing,
wherein the rear wall of the TMS housing is directly connected to a base of the distribution housing, and
wherein a bottom region of the cover of the core assembly and a bottom portion of the distribution housing collectively define a recess to enable access to the rear fluid connections.

16. The module of claim 11, wherein the distribution housing includes a base and one or more peripheral walls, wherein the TMS housing is provided with first and second lateral sidewalls and one or more top walls extending between the first and second lateral sidewalls, wherein the first and second lateral walls, the one or more top walls, and a portion of the base of the distribution assembly collectively define a pocket configured to receive one or more fluid lines.

17. The module of claim 16, further comprising:
one or more fluid receptacles,
wherein the one or more top walls of the TMS housing form a stepped structure including a first top wall, a second top wall, and an intermediate wall, the first top wall spaced apart from the second top wall, and the intermediate wall extending between and arranged substantially orthogonal to the first top wall and the second top wall, wherein the second top wall forms a bottom of the pocket and, wherein the one or more fluid receptacles extend from the second top wall.

18. A power control and accessory system module configured for use in a vehicle, the module comprising
a thermal management system (TMS) configured to receive and supply one or more fluids to one or more vehicle accessories to heat or cool the one or more vehicle accessories, wherein the TMS includes a TMS housing provided with one or more sidewalls;
a distribution assembly fixed to and lying along a first sidewall of the one or more sidewalls of the TMS housing, the distribution assembly configured to distribute electric power;
a core assembly, wherein the distribution assembly is disposed between the core assembly and the TMS housing;
a first power distribution unit provided with one or more first power receptacles arranged to face in a first direction; and
a second power distribution unit provided with one or more second power receptacles arranged to face in a second direction, wherein the second direction is different than the first direction, wherein the first and second power receptacles are configured to route electrical power to and from the distribution assembly.

19. The module of claim 18, wherein the second direction is substantially orthogonal to the first direction.

20. The module of claim 18, wherein the first power distribution unit is configured to deliver a first voltage, wherein the second power distribution unit is configured to deliver a second voltage, and wherein the second voltage is lower than the first voltage.

21. The module of claim 1, wherein the converter is disposed within the distribution assembly.

22. The module of claim 5, wherein the LVPDU is directly connected to the base.
